(19) United States
(12) Patent Application Publication
(10) Pub. No.: US 2007/0121461 A1
(43) Pub. Date: May 31, 2007

(54) Recording/reproduction method and recording/reproduction apparatus

(76) Inventors: Isao Kobayashi, Osaka (JP); Mamoru Shoji, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/572,150

(22) PCT Filed: Sep. 17, 2004
(86) PCT No.: PCT/JP04/14042

§ 371 Date: Nov. 15, 2006

(30) Foreign Application Priority Data
Sep. 18, 2003 (JP) 2003-325807

(51) Int. Cl. G11B 7/0045

(52) U.S. Cl. 369/59.11; 369/53.26; 369/116

(57) ABSTRACT

The recording/reproduction method of the present invention includes the steps of: repeating one of a recording operation and a reproduction operation for the optical disc n times (n: an integer greater than or equal to 2) while changing a recording/reproduction condition in a stepwise and monotonous manner m times (m: an integer greater than or equal to 2); determining m number of averaged index values obtained under the same recording/reproduction condition based on the (m×n) pieces of signal data reproduced from the optical disc; determining an optimum recording/reproduction condition based on the m number of averaged index values; and performing at least one of the recording operation and the reproduction operation for the optical disc in accordance with the optimum recording/reproduction condition.

### TECHNICAL FIELD

The present invention relates to a method and an apparatus for optimizing recording/reproduction condition for realizing a stable recording/reproduction system in view of variations in the track width and reflectance along the circumferential direction of the track, in an optical disc system that projects laser light and performs recording/reproduction of information.

### BACKGROUND ART

At present, there are various kinds of recordable optical discs used for image and sound recording or data storage for personal computers. Recording information which is optimal for the respective discs, such as recording signals and recording powers, is recorded on the recordable optical discs. However, even for mass-produced optical discs in which materials of optical disc medium such as film materials of recording layers and the structures of tracks are identical to one another, the thickness of substrates and/or the width of track pitches can be different, due to lot-to-lot discrepancy of the production process. Likewise, regarding optical disc drives performing recording/reproduction for optical discs, there are variations in the laser wavelength and the sensitivity of elements for receiving reflected light from the disc, depending on the accuracy of servo control such as focus control and/or tracking control of an optical head. That is, even if recording states such as recording powers, servo control and the like are set to be the same, the recording sensitivity could vary due to the individual differences among optical discs, recording/reproduction apparatuses, or the like. In order to prevent such a reduction in the recording sensitivity due to individual differences, a calibration operation is performed, e.g., at the time of removal of a recording medium. The “calibration” refers to control for optimizing the recording power or pulse shape to secure the signal quality of user data.

The typical recording calibration operation is performed using a test writing area provided within an inner peripheral portion as in DVD-RAM. FIG. 1 shows an example of a recording power calibration operation with respect to an optical disc. In portion (a) of FIG. 1, reference numeral 101 denotes an optical disc, 102 denotes a user data area, 103 denotes a power calibration area (PCA area), and 104 denotes a permanent information and control data area (PIC area). The user data area 102 is an area in which data information is to be recorded. The PCA area 103 is provided within the inner peripheral portion of the user data area 102 as a test writing area. The number of usage of the PCA area 103 and the position of the PCA area from which the recording starts are not limited. Disc information, such as recording powers, pulse widths and recording capacities, is recorded on the PIC area. Portion (b) of FIG. 1 shows the change of RF signal levels indicating the amounts of reflected light from the optical disc 101 for the respective recording powers. In the PCA area 103, the recording power typically recorded in the PIC area 104 is changed in a stepwise manner, and the RF signal level for each recording power is detected, thereby an optimum power for recording in the user data area 102 is determined depending on a change in the state such as the modulation or asymmetry.

One example of prior art that makes use of the above-described recording power calibration operation is disclosed in Japanese Laid-Open Publication No. 2002-170236. This prior art discloses a technique wherein a portion of a recording pulse train is replaced with pulses for detection and recorded by sector units, and wherein an optimum recording power is calculated by determining the change of each of the pulses in the modulation using the respective values obtained by sampling RF signals in a sampling circuit.

In rewritable optical discs, such as DVD-RAM, which generally has sector structures, the recording operation is performed in units of sectors. In some cases, the reflectance fluctuates along the circumferential direction of the track because there exist flaws on the track and/or dusts on the optical disc surface, or because variations in the thickness of recording layer and/or reflection layer occur during manufacturing. If the reflectance in all or some sectors in which the modulation is to be detected deviate from a predetermined value, the amount of reflected light from the optical disc will vary, so that the respective modulations corresponding to the stepwise changes in the recording power are not accurately detected. As a result, the recording power ultimately calculated from the modulation may become higher or lower than a desired optimum recording power.

The object of the present invention is to provide a method and an apparatus for optimizing the recording/reproduction condition for realizing a reliable optical disc that averagely detects an index value indicating the reproduction signal quality, including the modulation, even if the reflectance and the like vary along the circumferential direction of the track, and that calculates a more stable recording power or other recording/reproduction conditions.

### DISCLOSURE OF THE INVENTION

The recording/reproduction method according to the present invention is a recording/reproduction method for recording information onto an optical disc, or reproducing the information recorded on the optical disc. This method includes the steps of: repeating one of a recording operation and a reproduction operation for the optical disc n times (n: an integer greater than or equal to 2) while changing a recording/reproduction condition in a stepwise and monotonous manner m times (m: an integer greater than or equal to 2); determining m number of averaged index values obtained under the same recording/reproduction condition, based on the (m×n) pieces of signal data reproduced from the optical disc; determining an optimum recording/reproduction condition based on the m number of averaged index values; and performing at least one of the recording operation and the reproduction operation for the optical disc in accordance with the optimum recording/reproduction condition, thereby achieving the objective described above.

The recording/reproduction apparatus according to the present invention is a recording/reproduction apparatus for recording information onto an optical disc, or re-producing the information recorded on the optical disc. This apparatus includes an optical head for irradiating the optical disc with laser light; a laser light control section for controlling the laser light; an optical head control section for controlling the optical head; an optical disc controller for controlling the laser light control section and the optical head control section to repeat one of a recording operation and a reproduction operation for the optical disc n times (n: an integer greater than or equal to2) while changing a recording/reproduction condition in a stepwise and monotonous manner m times (m: an integer greater than or equal to 2); and a signal processing section for determining m number of averaged index values obtained under the same recording/reproduction condition, based on the (m×n) pieces of signal data reproduced from the optical disc. The optical disc controller determines an optimum recording/reproduction condition based on the m number of averaged index values, and controls the laser light control section and the optical head control section to perform at least one of the recording operation and the reproduction operation for the optical disc in accordance with the optimum recording/reproduction condition, thereby achieving the objective described above.

### BRIEF DESCRIPTION OF THE DRAWINGS

FIG. 1 is a diagram showing an example of recording calibration operation.

FIG. 2 is a construction view of an optical disc according to an embodiment of the present invention.

FIG. 3 is a diagram of a track shape in this embodiment.

FIG. 4 is a diagram of recording pulse waveforms and recording powers in this embodiment.

FIG. 5 is a schematic view of recording tracks in this embodiment.

FIG. 6 is a diagram showing changes in the recording power, and reproduction signals from the recording track in this embodiment.

FIG. 7 is a diagram showing the relationship of the modulation characteristic and the target modulation with respect to the recording power.

FIG. 8 is a flowchart showing the recording power deriving operation by the modulation in this embodiment.

FIG. 9 is a block diagram of a recording/reproduction apparatus according to this embodiment.

FIG. 10 is a block diagram of the recording/reproduction apparatus according to this embodiment, in the case where a signal processing circuit is used.

FIG. 11 is a block diagram of the recording/reproduction apparatus according to this embodiment, in the case where a signal processing circuit is not used.

FIG. 12 is a diagram showing the asymmetry characteristic with respect to the recording power in this embodiment.

FIG. 13 is a flowchart showing the recording power deriving operation by the asymmetry in this embodiment.

FIG. 14 is a diagram showing the jitter characteristic with respect to the recording power in this embodiment.

FIG. 15 is a flowchart showing the recording power deriving operation by the jitter characteristic in this embodiment.

FIG. 16 is a diagram explaining the edge deviation of recording marks, and the pulse adjustment in this embodiment.

FIG. 17 is a graph showing the shift characteristic with respect to the correction amount of recording pulse in this embodiment.

FIG. 18 is a flowchart showing the recording pulse condition deriving operation by the shift in this embodiment.

FIG. 19 is a flowchart showing the tilt control operation by the jitter at the time of reproduction in this embodiment.

FIG. 20 is a flowchart showing the tilt control operation by the jitter at the time of recording in this embodiment.

FIG. 21 is a flowchart showing the tracking control operation by the jitter at the time of reproduction in this embodiment.

FIG. 22 is a flowchart showing the tracking control operation by the jitter at the time of recording in this embodiment.

FIG. 23 is a flowchart showing the focus control operation by the jitter at the time of reproduction in this embodiment.

FIG. 24 is a flowchart showing the focus control operation by the jitter at the time of recording in this embodiment.

FIG. 25 is a flowchart showing the spherical aberration correction control operation by the jitter at the time of reproduction in this embodiment.

FIG. 26 is a flowchart showing the spherical aberration correction control operation by the jitter at the time of recording in this embodiment.

FIG. 27 is a flowchart showing the frequency characteristic control operation of a waveform equalizer by the jitter in this embodiment.

FIG. 28 is a diagram showing changes in the recording power in this embodiment.

FIG. 29 is a diagram showing changes in the recording power in this embodiment.

FIG. 30 is a diagram showing changes in the recording power and reproduction signals from a recorded track in this embodiment.

FIG. 31 is a diagram showing changes in the recording power in this embodiment.

FIG. 32 is a diagram showing changes in the recording power and deriving methods for optimum recording powers in this embodiment.

FIG. 33 is a diagram showing the relationship between the circumferential positions in the track and the respective optimum recording powers.

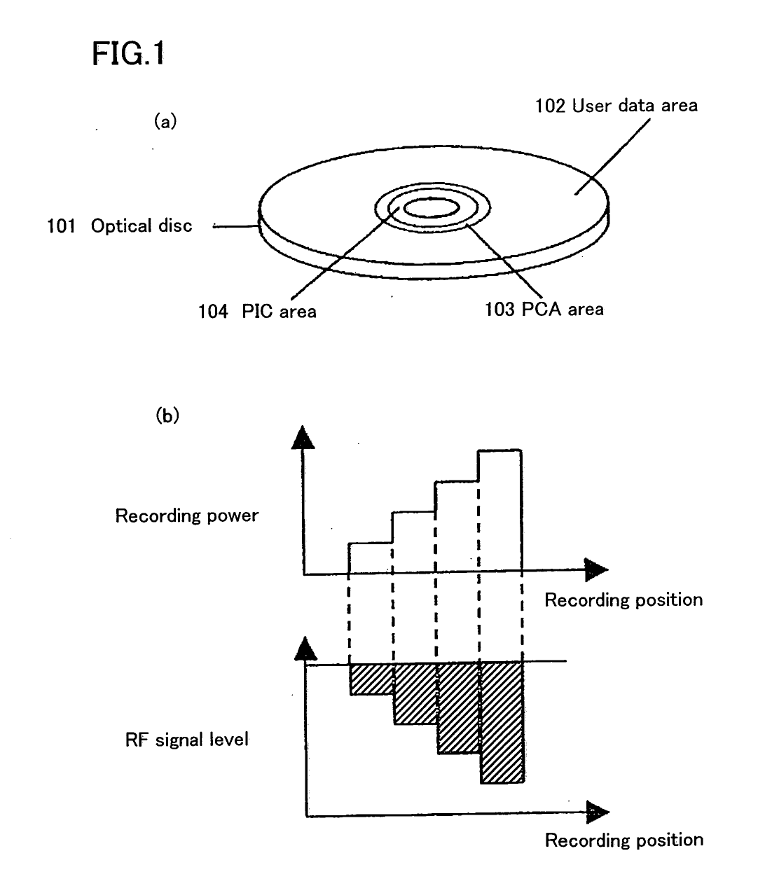

### BEST MODE FOR CARRYING OUT THE INVENTION

Hereinafter, an embodiment according to the present invention will be described with reference to the drawings.

In this embodiment, the descriptions are made of the case where a Blu-ray disc (BD) is employed.

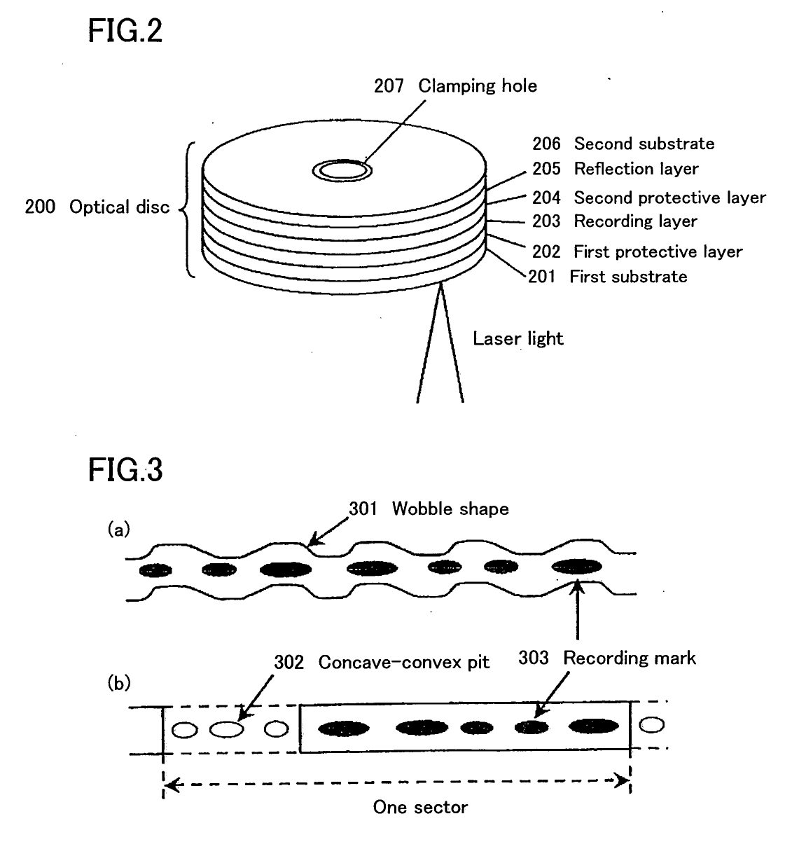

FIG. 2 is a construction view of an optical disc according to this embodiment. As shown in FIG. 2, an optical disc 200 includes a first substrate 201, a first protective layer 202, a recording layer 203, a second protective layer 204, a reflection layer 205, and a second substrate 206. The optical disc 200 has a clamping hole 207 formed therein.

The first substrate 201 and the second substrate 206 are formed of polycarbonate resin or the like. The first protective layer 202 and the second protective layer 204 protect the recording layer 203, and also achieve the improvement in quality of reproduction signals by taking advantage of multiple reflection. The clamping hole 207 is provided for transferring the rotation of a spindle motor through an axial rod to rotate the optical disc.

The recording layer 203 has a plurality of spiral tracks (not shown). The track is assumed to have a land-groove structure (not shown). In this embodiment, information recorded in the form of a predetermined modulation rule, such as (1, 7) modulation code, is recorded in groove portions, as a recording mark. Therefore, descriptions regarding tracks in the figures corresponding to this embodiment are mainly ones regarding groove portions, and the land portions are omitted from descriptions. The formation of a recording mark is performed by changing the optical characteristic of the material of a recording layer by the recording power of laser light. The laser light is projected from the first substrate 201 side. In this embodiment, the material of a recording layer is assumed to be a phase change material, but an organic dye film may instead be employed.

Also, in this embodiment, the track is assumed to include address information by forming the track into a wobble shape obtained by causing the track to meander. FIG. 3 illustrates track shapes. Portion (a) of FIG. 3 shows wobble shape 301 in this embodiment. The tilt angle, direction, and the like of the wobble waveform is assumed to cause address information (digital signal) to be determined. Alternatively, however, the address information may be formed by a method other than the wobble shape 301. For example, as shown in portion (b) of FIG. 3, the track is constituted of a plurality of sectors, and in each of the sectors, address information is formed of concave-convex pits 302. The concave-convex pits 302 changes the amount of reflected light of a projected laser light, thereby allowing the signals “0” and “1” of the address information to be identified. In this way, the address information may be formed by a method other than the wobble shape 301.

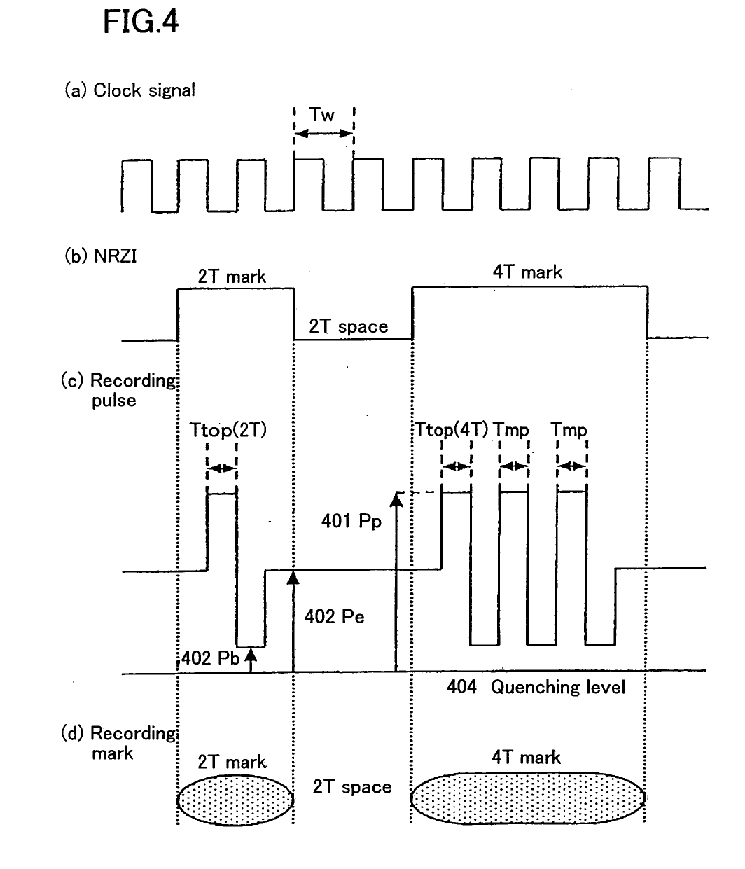

FIG. 4 is a diagram explaining recording pulse waveforms and recording powers in this embodiment. Portion (a) of FIG. 4 shows a channel clock serving as a reference signal when recording data is produced. The period Tw of this channel clock is 66 MHz, and the period Tw determines the time interval for recording marks and spaces in recording signals NRZI (Non Return to Zero Inverting) shown in portion (b) of FIG. 4.

Portion (c) of FIG. 4 shows a multi-pulse train of laser light for forming recording marks. The recording power Pw of the multi-pulse train is set to any one of a heating Pp power 401, a cooling Pb power 403, and erasing Pe power 402. The heating Pp power 401 and cooling Pb power 403 are powers necessary for forming a recording mark. The erasing Pe power 402 is a power necessary for erasing an existing recording mark to form a space. The Pp power 401, Pe power 402, and Pb power 403 are set with a quenching level 404 detected when laser light is quenched, as a reference level.

The top pulse width Ttop of multi-pulse train is set for each of the pulse trains of lengths of 2T, 3T, 4T or more. In a multi-pulse train of 3T or more, there are one or more pulse widths Tmp subsequent to the pulse width Ttop. The pulse width Tmp is set to be the same irrespective of the length of recording mark.

The laser light-emitting conditions at the time of recording, such as values of recording powers and pulse widths of the multi-pulse train, are recorded in the PIC area 104. When the recording power Pw is changed in this embodiment, the pulse width is assumed to be constant irrespective of the change in recording power. Therefore, if the recording power and pulse width of the multi-pulse train recorded in the PIC area 104 can be reproduced and laser light can be applied to a recording film, recording marks, as shown in portion (d) of FIG. 4, can be formed.

Herein, as the recording signal for calculating the modulation, a single signal of the longest mark of modulation code is used. For example, in the (1, 7) modulation code, the single signal of the longest mark of modulation code is a 8T single signal. The “8T single signal” refers to a signal in which 8T marks and 8T spaces are alternately repeated wherein T is taken as one cycle length of the recording clock Tw. The reason why the 8T single signal has been selected is that it is necessary to form recording marks having a stable mark width because the modulation changes depending on the size of recording mark, especially on the mark width. For example, in the case where the mark width at the leading edge of a recording mark changes due to the difference in the rise time of the Ttop, owing to variations in the optical characteristic of optical head, the shorter the recording mark, the larger becomes the ratio of the change in the mark width to the entire mark. Hence, even if the mark width changes at the leading edge or trailing edge of recording mark, the longer recording mark can obtain a more stable mark width at the central portion thereof, and hence the longest mark is the most effective. Also, the purpose of using a single signal here is to avoid inter-code interference with other signals, and to prevent the number of samples from being reduced by unwanted signals when determining the modulation.

Recorded/unrecorded state of a track to be used in this embodiment will be described.

If there exists a relatively large recording mark which is left written by a recording power of a high output when an optical disc is last used, the recording mark may not be completely erased when the recording mark is overwritten with a recording power of a low output, instead a larger recording mark than a recording mark that would be originally formed under a lower output may be formed, thereby changing the modulation to be detected. Also, under the influence (crosstalk) of the recorded and unrecorded states, adjacent tracks may vary in the RF signal level, and the modulations detected after recording has been made under the same recording power condition may differ between tracks. In order to avoid the occurrence of such differences in the detection result of the RF signal or modulation, recording marks must not be formed until the existing recording marks are erased. With this being the case, DC erasing (hereinafter, referred to as an “erasing operation”) on three tracks including a track on which recording/reproduction is to be performed and adjacent tracks, is performed in advance by the Pe power 402, irrespective of the presence or absence of a recording mark. In this embodiment, the DC erasing is performed for three tracks including adjacent tracks, but the erasing operation may also be performed on more than three tracks or three tracks. When the influence of the aforementioned crosstalk can be neglected (e.g., in the case where the track structure is of a type having a long track pitch), the erasing operation on only the track on which recording/reproduction is to be performed, allows the detection of the modulation using the same reference. Also, when the optical disc on which there is no recording mark left written is used for the first time, or when it can be identified and selected that the above-described three tracks are in an unrecorded state, the erasing operation does not need to be performed.

Next, descriptions are made of operations for forming recording marks, repeated n times (n: an integer greater than or equal to 2) while changing the recording power Pw of the multi-pulse train m times (m: an integer greater than or equal to 2). In this embodiment, as a unit for changing the recording/reproduction condition, an address unit is used. For example, in the case of a BD, in the vicinity of the inner periphery of 23 mm where test recording is performed, there exist about 32 address units along one round of a track, and therefore, the recording/reproduction condition can be determined in advance to be n=4, m=8, or the like.

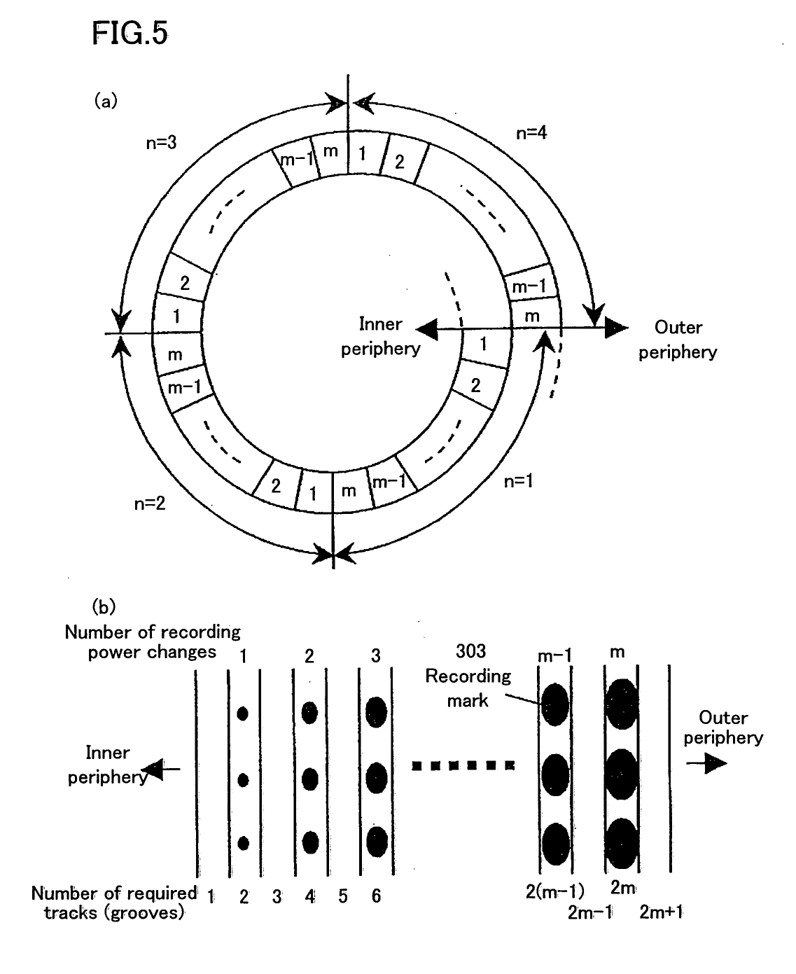

The range of the track required for detecting the modulation by changing the recording power will be described with reference to FIG. 5. Portion (a) of FIG. 5 shows an example of the use of the track in the case where m time changes of the recording power on one track are performed n times. Portion (b) of FIG. 5 shows an example of the use of the track in the case where the recording power is changed m times for each track.

As shown in portion (a) of FIG. 5, in this embodiment, one round of the track is divided into four parts (in this example, the operation repetition number n=4), whereby variations along the circumference of the track are averaged. Therefore, even if the recording power is changed m times, the same recording power is newly set for each quarter of a turn of the optical disc. As a result, it is possible to obtain a comparable performance to that of means for recording for one round of the track using the same power and detecting modulations at four points. In addition, as shown in portion (b) of FIG. 5, recording over one round of the track using the same power requires (2 m+1) tracks, including the case where adjacent tracks are in an unrecorded state. In contrast, in this embodiment, since the recording power is changed m times per round of the track, only three tracks including adjacent tracks are employed. This makes it possible to eliminate the use of unnecessary tracks and unnecessary recording time.

The changes in recording power and the calculation of modulation are described below.

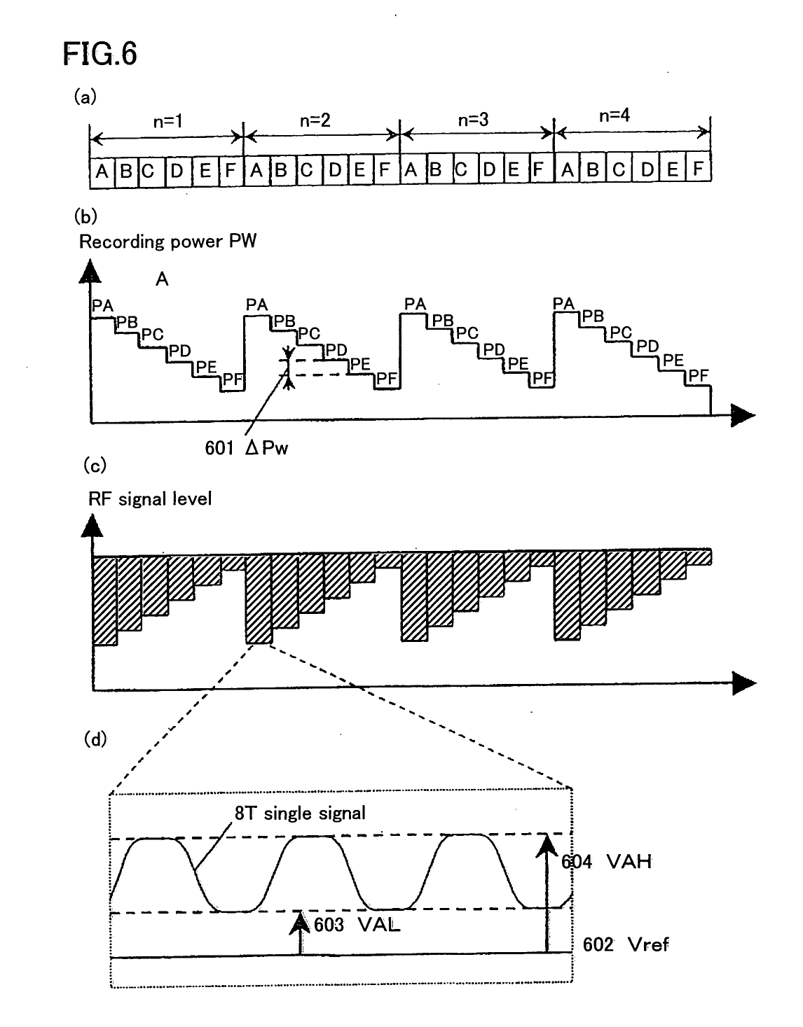

FIG. 6 shows the changes in recording power, and levels of RF signals serving as signals indicating the amount of reflected light from the track on which the recording has been made by the above-described recording power. Portion (a) of FIG. 6 expresses one round of a track illustrated in portion (a) of FIG. 5 in the form of a straight line. Here, symbols A to F denote recording ranges of respective recording powers when the number of changes in recording power is taken as six (i.e., m=6). The lengths of all recording ranges are the same irrespective of the output value of recording power.

However, all recording ranges are not necessarily required to have the same length. For example, under steep power change conditions, the recording range is recorded by a recording power other than a desired power value, so that the signal detection accuracy decreases. Accordingly, the recording range may be changed with respect to a specific recording power, for example, by setting recording powers in the recording ranges of symbols A and B to be the same.

Portion (b) of FIG. 6 shows changes in the recording power Pw corresponding to the recording ranges of symbols A to F. Recording powers PA, PB, PC, PD, PE, and PF in portion (b) of FIG. 6 denotes output values of the Pp power 401. The output values of the Pe power 402 and Pb power 403 are calculated so that each of the ratios Pe/Pp and Pb/Pp is kept constant. Herein, the ratios Pe/Pp and Pb/Pp are determined based on the information recorded in the PIC area 104. However, for example, when the Pe power 402 or the Pb power 403 are fixed and the recording characteristic of the Pp power 401 alone is to be detected, the ratios Pe/Pp and Pb/Pp may be changed depending on the usage.

As for the general tendency of the change in recording power Pw in this embodiment, the recording power Pw is stepwise changed from a high output to a low output. However, if the same recording power is newly set for each quarter of a turn of the optical disc, the recording power change may be from a low output to a high output. Moreover, the recording power change may be irregular instead of stepwise. The amount of change in recording power Pw is assumed to be a predetermined value ΔPw 601, which is a constant amount shown in portion (b) of FIG. 6. Here, the desired predetermined value ΔPw 601 in this embodiment is 5% of the upper limit of the recording power, defined by the BD standard. This is because, at the amount of change lower than or equal to 5%, the change in detection signal is small, so that it is necessary to repeat again an operation for changing the recording power, as a result, the run time increases. On the other hand, at the amount of change higher than or equal to 5%, it is necessary to increase the length of the recording range due to the steep power change as described above, so that the number of m changes in the recording power can decrease. Therefore, the predetermined value ΔPw 601 is different between a single-layered disc, in which the recording power is recorded with a low output, and a two-layered disc, in which the recording power is recorded with a high output. Furthermore, regarding a disc of a type that differs in the recording power from the above-described discs, e.g., DVD-RAM, the value ΔPw 601 thereof is different from that of the above-described discs.

Herein, a brief explanation will be provided about the initial value for changing the recording power. The recording power Pw recommended by disc manufacturers can be determined by the following Expression 1.
Pw=Pind*ρ (Expression 1)

Herein, the recording power Pind and constant ρ are recorded in the PIC area 104. A modulation mk detected when recording is made by the recording power Pind is also recorded therein. Therefore, when the modulation mk is taken as a target to be detected, it is desirable to take the recording power Pind or a recording power in the neighborhood thereof, i.e., (Pind±α), as an initial value. Here, α is an arbitrary power value, and it is assumed to be, e.g., the predetermined value ΔPw 601. Meanwhile, there is a difference in optical characteristics among optical heads. Also, e.g., due to the adhesion of dust particles to the optical head, even if recording, is made by the recording power Pind, the modulation mk is not necessarily detected in all optical disc drives. For these reasons, it should be noted that the recording power Pind and a recording power Pk described later do not always conform to each other.

Portion (c) of FIG. 6 shows the change in RF signal level along one round of the track, the change having been obtained by recording while stepwise changing the recording power Pw as described above. Portion (d) of FIG. 6 is an enlarged view of the RF signal reproduced from the recording area where recording has been made by the recording power PA. In portion (d) of FIG. 6, reference numeral 602 denotes a signal level Vref in the state where there is no amount of reflected light from the optical disc, and provides a reference level when the modulation of RF signal is calculated. Reference numeral 603 denotes the minimum value VAL of RF signal relative to the Vref, while 604 denotes the maximum value VAH of RF signal relative to the Vref. Accordingly, in four recording areas (n=4) where recording has been made by the recording power PA, the detected signal levels VAH 604 and VAL 603 are averaged. That is, a modulation obtained by averaging variations along one round of the track can be calculated by the following Expression 2.
mA=(VAH−VAL)/VAH (Expression 2)

Likewise, the modulations of RF signals reproduced from the respective recording areas recorded by the other recording powers PB, PC, PD, PEA, and PF can also be obtained.

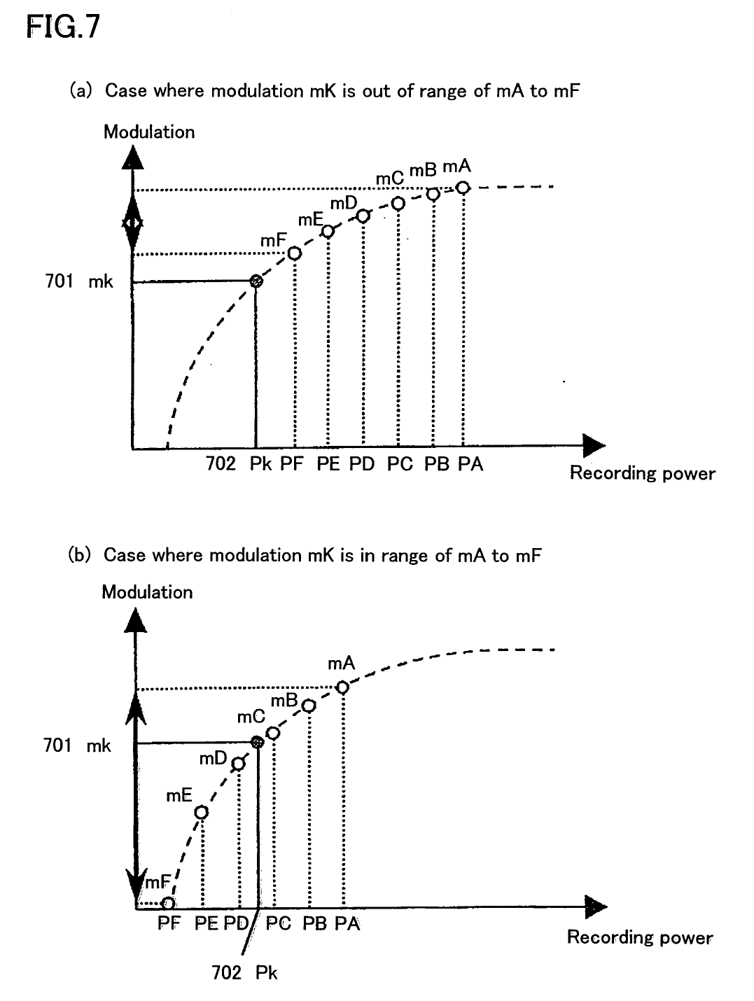

Next, references are made to a method for deriving an optimum recording power from the modulation characteristic determined by the change in recording power. FIG. 7 shows the modulations mA to mF corresponding to the respective recording powers PA to PF. An optimum recording power is determined by using these six (m=6) modulations mA to mF as index values of signal quality. Here, reference numeral 701 denotes a modulation mk that is a target value to be detected, and 702 denotes a recording power Pk by which the modulation mk 701 is detected.

First, it is determined whether the target modulation mk is included in the range of the modulations mA to mF. Portion (a) of FIG. 7 shows the case where the target modulation mk 701 is outside the range of the modulations mA to mF, while portion (b) of FIG. 7 shows the case where the target modulation mk 701 is in the range of the modulations mA to mF.

When the modulation mk is outside the range of the modulations mA to mF as shown in portion (a) of FIG. 7, it is necessary to change again the recording power to detect modulations including the modulation mk. Herein, the track to be detected may be shifted to another track, or the same track may be reused, but in either case, the recording marks must be erased in advance as described above. However, when the same track is reused, it is sufficient only to erase the central track on which recording marks have been formed by the first-time recording operation, since the adjacent tracks have not undergone recording. The range of recording power to be executed again is determined by the recording power that is second nearest to the modulation mk, as a reference. In portion (a) of FIG. 7, the recording power that is second nearest to the modulation mk corresponds to the recording power PE. The reason why the recording power that is second nearest to the modulation mk is selected as the reference is as follows. For example, in portion (a) of FIG. 7, if the target modulation mk is 40%; the modulation mF at the time when recording is made by the recording power PF is detected as 40.5%; and the second-time recording power change is towards a low-output relative to the recording power PF, then, provided that the modulation at the time when recording is made by the recording power of the power reference (i.e., the same one as the first-time recording power PF) is 39.5%, the detected result of the target modulation of 40% is not obtained even in the second-time recording power change. This necessitates the execution of a third-time recording power change. However, in the third-time change and subsequent recording power changes, the same phenomena as that in the second-time change would occur. To avoid the occurrence of such misdetection, when a next-time recording power change is to be made, a recording power that is second nearest to the modulation mk is adopted as a reference. Hence, in the case where the modulation mk is the modulation mF or a lower modulation, the recording power PE is set to be the initial value PA at a next-time recording power change. On the other hand, in the case where the modulation mk is the modulation mF or a higher modulation, a recording power (PB+(m−1)*ΔPw 601), that is, (PB+5*ΔPw 601) is set to be the initial value PA at a next-time recording power change.

When the modulation mk is in the range of the modulations mA to mF as shown in portion (b) of FIG. 7, the nearest modulation m+ that is higher than or equal to the modulation mk and that is the nearest to mk, and the nearest modulation m− that is lower than the modulation mk and that is the nearest to mk, are identified. In portion (b) of FIG. 7, the nearest modulation m+ corresponds to the modulation mC, while the nearest modulation m− corresponds to the modulation mD. Next, using a linear approximation of two points of the nearest modulations m+ and m− and the value of the modulation mk, the recording power Pk is calculated by which the modulation mk is estimated to be detected. Lastly, the power used when data is actually recorded in the user data area 102, namely, an optimum recording power Pbest can be determined by the following Expression 3.
Pbest=Pk*ρ (Expression 3)

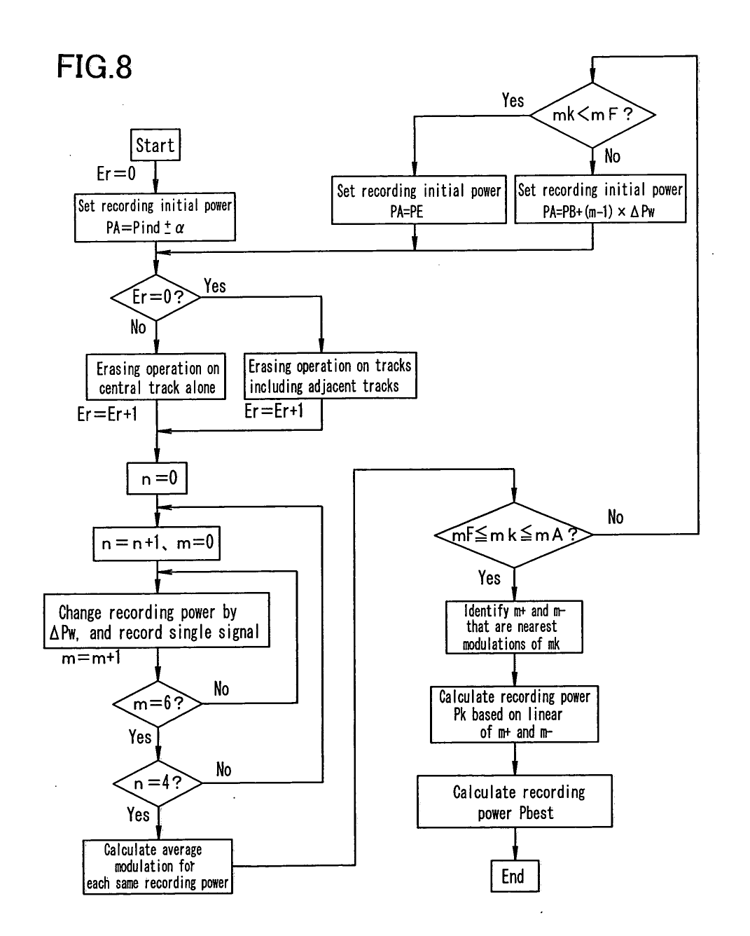

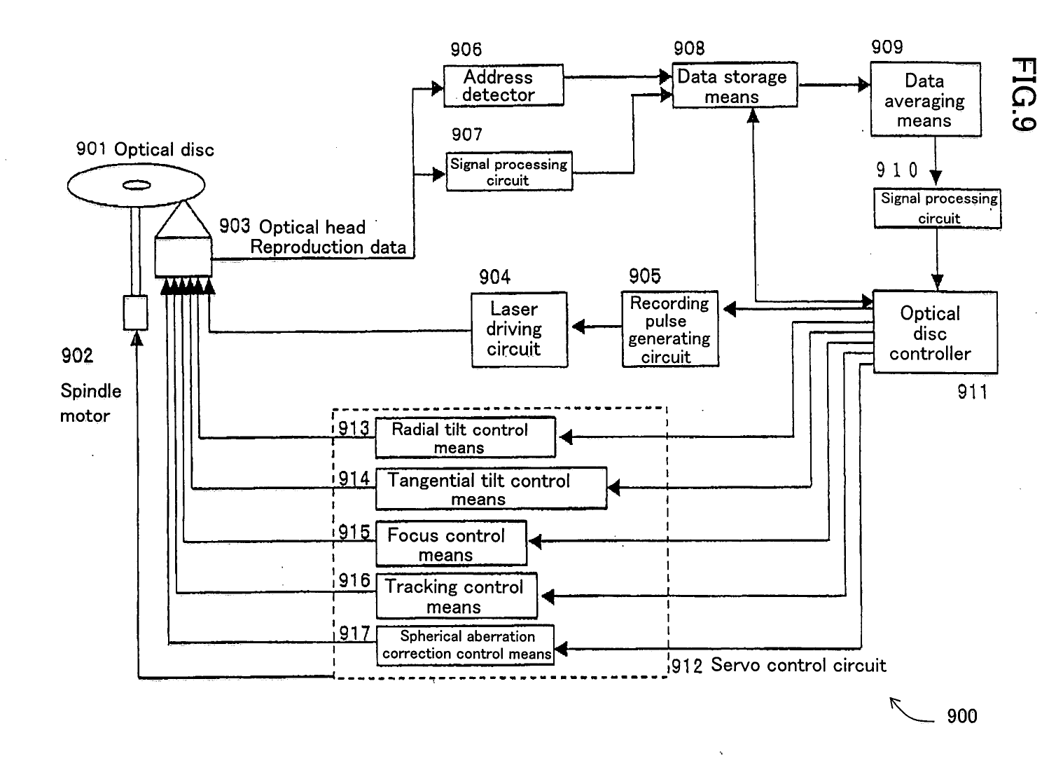

The recording power deriving processes described above are collectively shown in FIG. 8. In FIG. 8, an integer Er is provided for determining the number of erasing operations. As described before, when the first-time recording power change is made, an erasing operation is performed on tracks including adjacent tracks, but for the second-time recording power change, the erasing operation is performed on only the central track on which the recording has been made at the first-time power change. Also, an upper limit value Ermax (e.g., 10) of the number of erasing operations is provided. If the number Er of erasing operations exceeds the Ermax value, it is determined that the track in use is a source of trouble, and the track to be erased is shifted to another track. In this way, the Ermax value can be used as means for determining the shifting of the track to be erased to another track.

In the example illustrated in portion (a) of FIG. 6, all recording ranges of symbols A to F have the same length, but all recording ranges are not necessarily required to have the same length. For example, in the example shown in portion (a) of FIG. 6, when a steep change in the recording power is needed as in the case where the recording power transits from PF to PA, the recording power is changed, and until the recording power after the change stabilizes, recording is to be performed by the recording power, which is other than the desired recording power PA. It is therefore difficult to perform recording by the desired recording power PA over the entire recording range of symbol A. This reduces the reliability of the recording power in the recording range of symbol A.

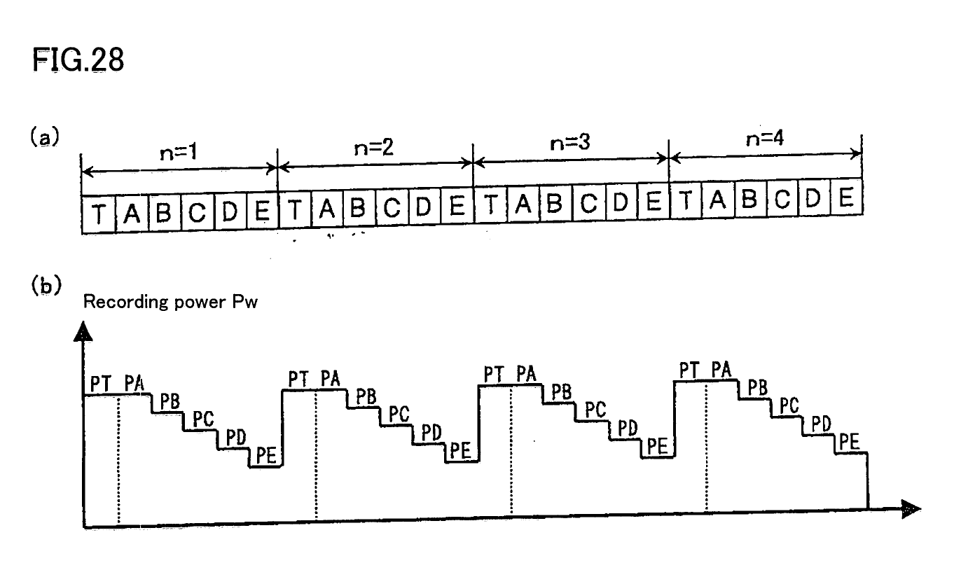

With reference to FIG. 28, descriptions will be made of a method for solving the problem that the reliability of recording power decreases when the recording power steeply changes.

As in the case of portion (a) of FIG. 6, portion (a) of FIG. 28 expresses one round of the track illustrated in portion (a) of FIG. 5 in the form of a straight line. In portion (a) of FIG. 28, symbols A to E denote recording ranges of respective recording powers when the number of changes in recording power is taken as five (m=5). The lengths of all recording ranges of symbols A to E are the same irrespective of the output value of recording power.

In portion (a) of FIG. 28, a symbol T denotes a top recording range for each n. The recording range of symbol T is disposed between the recording range of symbol E and that of symbol A. The recording ranges of symbols A to E are each used for determining an index value indicating the signal quality (e.g., the modulation of a reproduction signal), whereas the recording range of symbol T is not used to determine an index value indicating the signal quality. The length of the recording range of symbol T may be the same as that of each of the recording ranges of symbols A to E, or alternatively, may be longer than that of each of the recording ranges of symbols A to E. For example, the length of the recording range of symbol T may be twice that of each of the recording ranges of symbols A to E. In the case where the recording power steeply changes, the length of the recording range of symbol T is designed so as to correspond to the time before the recording power becomes stable after it has been changed.

Portion (b) of FIG. 28 shows changes in the recording power Pw corresponding to the recording ranges of symbol T and symbols A to E shown in portion (a) of FIG. 28. In the example illustrated in portion (b) of FIG. 28, the levels of the recording powers PA to PE decrease by a fixed value in a stepwise and monotonous manner. The recording power PT is set to the same level as that of the recording power PA. This may not allow the recording power to become the desired recording power PA in the recording range of symbol T, but can ensure that the recording power becomes the desired recording power PA in the recording range of symbol A. As a result, the reliability of the recording power in the recording range of symbol A is prevented from decreasing. Since the reproduction signal obtained from the recording range of symbol T is not used to determine the index value indicating the signal quality, it does not affect the reliability of recording power.

In this manner, in FIG. 28, the method for solving the problem of reduction in the reliability of recording power has been explained, taking the case where the recording power is stepwise changed from a high power to a low power for each n, as an example. This method can also be applied to the case where the recording power is stepwise changed from a low power to a high power for each n.

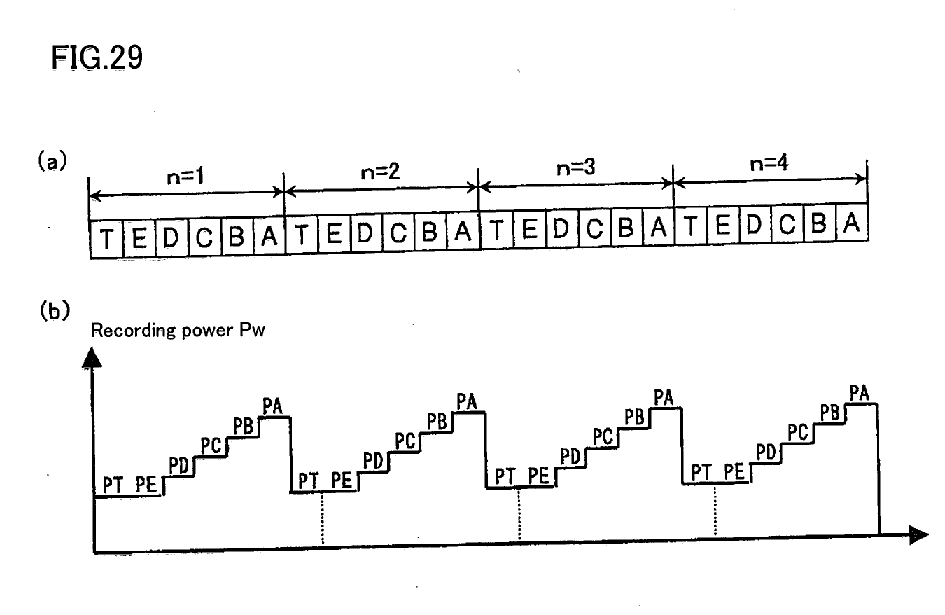

With reference to FIG. 29, descriptions will be made of a method for solving the problem that the reliability of recording power decreases when the recording power steeply changes.

Portion (a) of FIG. 29 is identical to portion (a) of FIG. 28 except that the ordering of the recording ranges of symbols A to E is the reverse of that of portion (a) of FIG. 28. The length of the recording range of symbol T is determined as described above in reference to portion (b) of FIG. 28.

Portion (b) of FIG. 29 is identical to portion (b) of FIG. 28 except that the levels of the recording powers PE to PA increase by a fixed value in a stepwise and monotonous manner. In the example illustrated in portion (b) of FIG. 29, the recording power PT is set to the same level as that of the recording power PE. This may not allow the recording power to become the desired recording power PE in the recording range of symbol T, but can ensure that the recording power becomes the desired recording power PE in the recording range of symbol E. As a result, the reliability of the recording power in the recording range of symbol E is prevented from decreasing. Since the reproduction signal obtained from the recording range of symbol T is not used to determine the index value indicating the signal quality, it does not affect the reliability of recording power.

Herein, instead of providing the recording range of symbol T shown in FIG. 28 and FIG. 29, it is possible to limit the measurement range such that the leading portion of each of the recording ranges is not used to determine the index value indicating the signal quality. In this case, it is possible to obtain an effect similar to the effect obtained by providing the recording range of symbol T as described above.

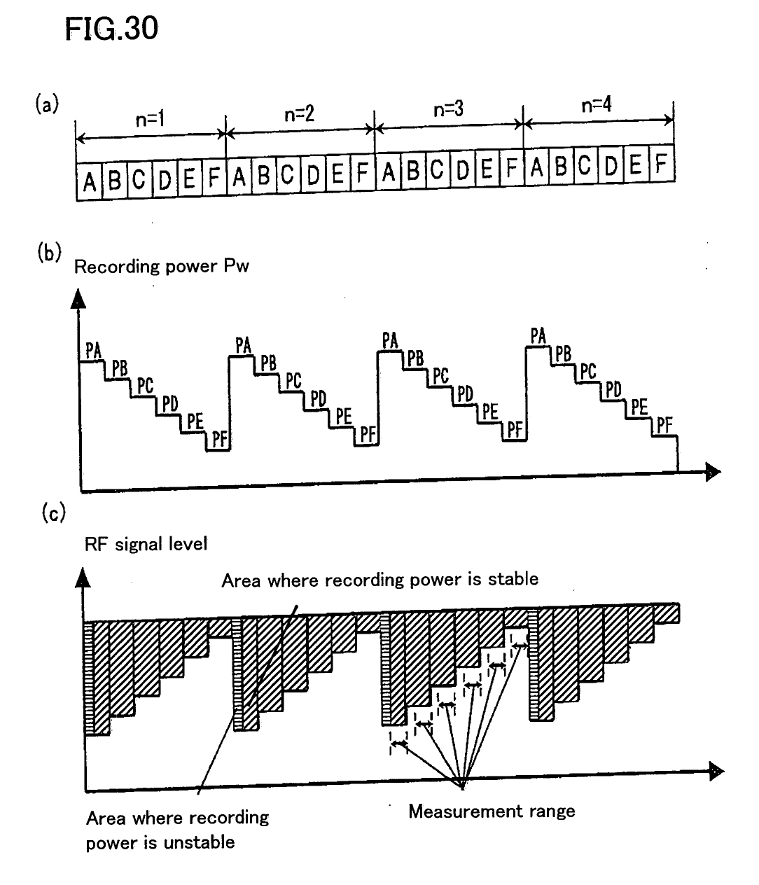

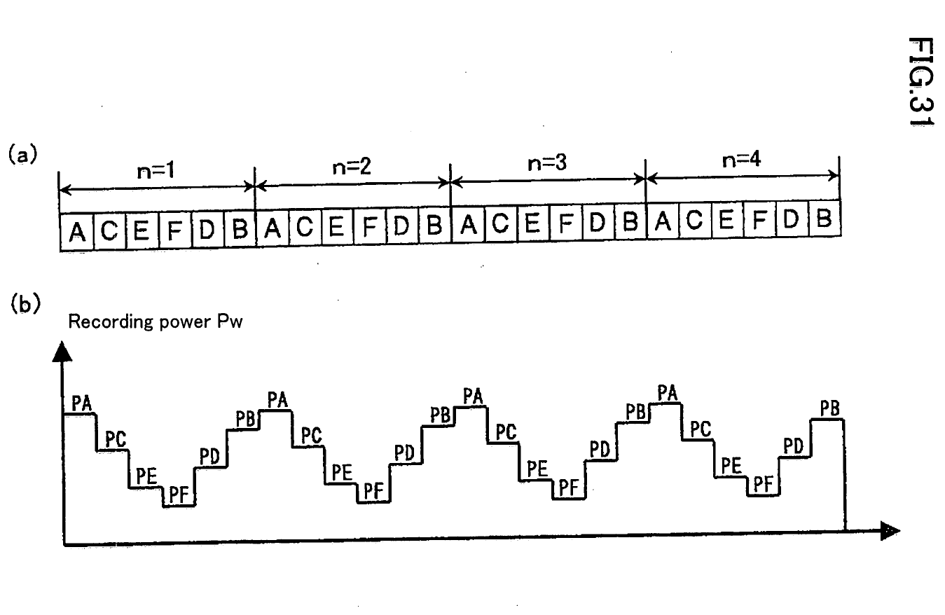

With reference to FIG. 30, descriptions will be made of a method for solving the problem that the reliability of recording power decreases when the recording power steeply changes.

In portion (a) of FIG. 30, as in the case of portion (a) of FIG. 6, symbols A to F denote recording ranges of the respective recording powers when the number of changes in the recording power is taken as six (i.e., m=6). Also, as in the case of portion (b) of FIG. 6, portion (b) of FIG. 30 shows changes in the respective recording powers PW corresponding to the recording ranges of symbols A to F. Furthermore, as in the case of portion (c) of FIG. 6, portion (c) of FIG. 30 shows the level of RF signal reproduced from each of the recording ranges recorded by the recording power Pw.

In the example illustrated in portion (c) of FIG. 30, the RF signal reproduced from the leading portion of each of the recording ranges of symbols A to F is not used to determine an index value indicating the signal quality. This is because the recording power corresponding to the leading portion of the recording range of symbol A is not stable. The measurement range is set to be a range excluding the leading portion of the respective recording ranges. Here, in order to unify the measurement conditions, it is desirable to use, also in the recording ranges of symbols B to F, the same measurement range as that in the recording range of symbol A. However, in the recording ranges of symbols B to F, the entire range of each of the recording ranges may be used as a measurement range. An RF signal reproduced from each of the measurement ranges of symbols A to F is used to determine an index value indicating the signal quality. This can ensure that the recording power becomes a desired recording power in each of the recording ranges of symbols A to F. As a result, the reliability of the recording power in each of the recording range is prevented from decreasing.

In FIG. 30, the method for solving the problem of reduction in the reliability of recording power has been explained, taking the case, where the recording power is stepwise changed from a high power to a low power for each n, as an example. This method can also be applied to the case where the recording power is stepwise changed from a low power to a high power for each n.

With reference to FIG. 31, explanations will be made of a method for changing the recording power so as not to steeply change.

FIG. 31 is similar to FIG. 6. However, FIG. 31 is different from FIG. 6 in that the ordering of the recording ranges of symbols A to F is the reverse of that of FIG. 6. Specifically, as shown in portion (b) of FIG. 31, the recording power Pw changes in the order of the recording powers PA, PC, PE, PF, PD, and PB for each n. The levels of the recording powers PA to PF shown in portion (b) of FIG. 31 are identical to those of the recording powers PA to PF shown in portion (b) of FIG. 6. Therefore, the change of the recording power Pw is not a fixed amount, but, in the recording power Pw, a change of two steps or more exists at least one time. However, there exists no steep change in the recording power as in the case shown in portion (b) of FIG. 6 where the recording power transits from the recording power PF to the recording power PA. Thus, the method shown in FIG. 31 prevents the recording power from steeply changing, thereby eliminating the reduction in reliability of the recording power.

Meanwhile, without determining the average value of data of n signals, n optimum recording/reproduction conditions (e.g., recording powers) may be determined in correspondence with the circumferential position on the track, based on the relationship between the recording power and the modulation for each n.

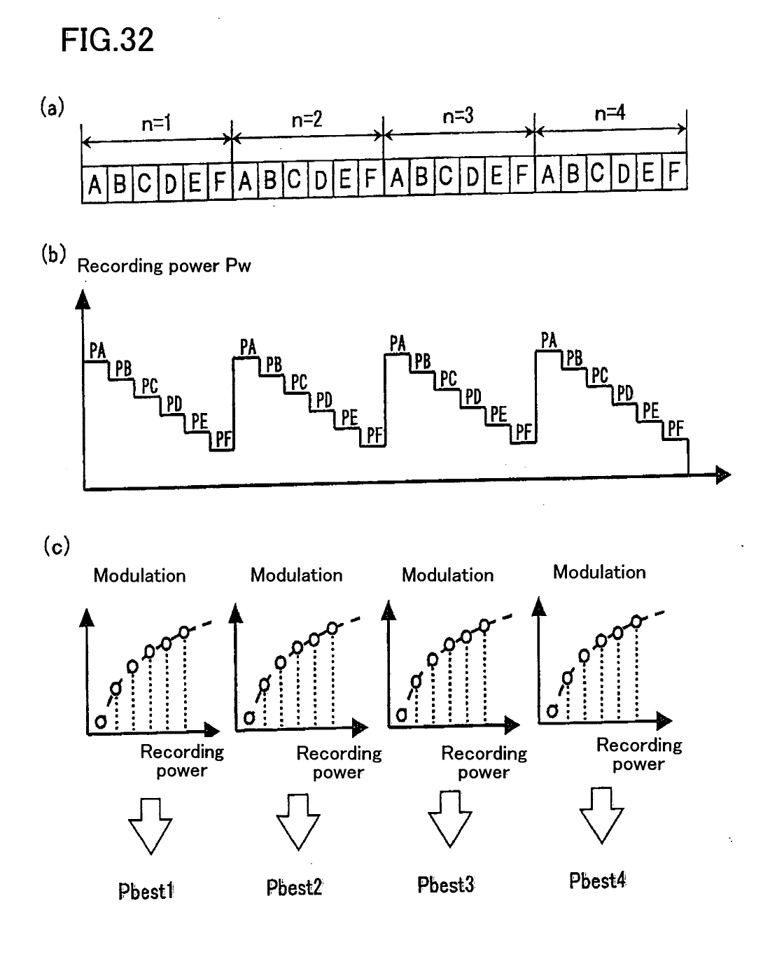

With reference to FIG. 32, explanations will be provided of a method for determining four (n=4) optimum recording/reproduction conditions (e.g., recording powers) in correspondence with the circumferential position on the track.

Portions (a) and (b) of FIG. 32 are similar to portions of (a) and (b) of FIG. 6, respectively.

Portion (c) of FIG. 32 shows how to determine four optimum recording powers (Pbest1, Pbest2, Pbest3, and Pbest4) from four relationships between recording powers and modulations.

For example, consider the case of n=1. The modulation mA is calculated by Expression 2, from the RF signal reproduced from the recording area where recording has been made by the recording power PA. In this manner, the modulation mA corresponding to the recording power PA is calculated. Likewise, modulations mB, mC, mD, mE, and mF, respectively corresponding to the recording powers PB, PC, PD, PE, and PF are calculated. From the respective relationships between these six recording powers and six modulations, the optimum recording power Pbest1 for n=1 is calculated. This method is the same as the method described with reference to FIG. 7. Similarly, an optimum recording power Pbest2 for n=2, optimum recording power Pbest3 for n=3, and optimum recording power Pbest4 for n=4 are calculated, respectively.

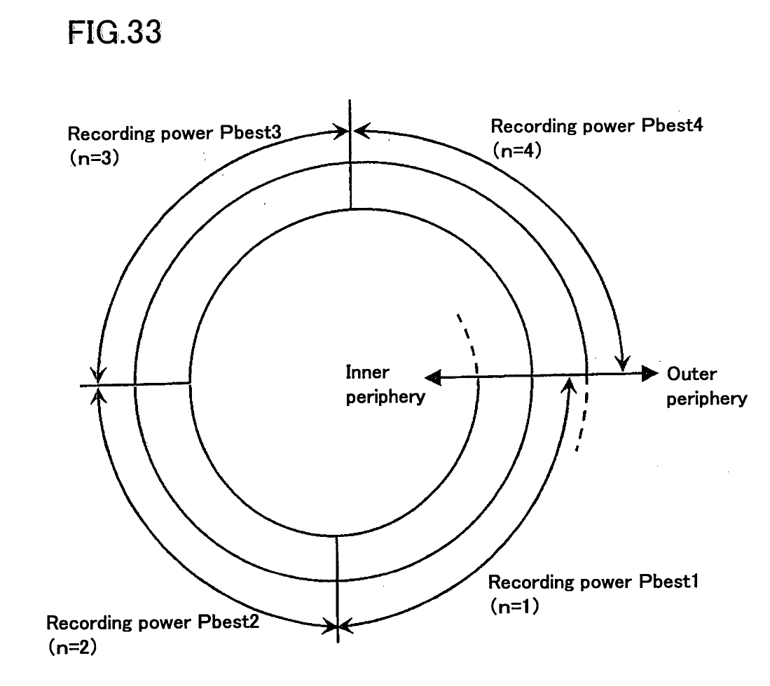

FIG. 33 shows the relationships between the circumferential positions on the track and the optimum recording powers Pbest1, Pbest2, Pbest3, and Pbest4. As shown in FIG. 33, the optimum recording power Pbest1 is used for the quarter round of the track, corresponding to n=1. Likewise, the optimum recording power Pbest2 is used for the quarter round of the track, corresponding to n=2, the optimum recording power Pbest3 is used for the quarter round of the track, corresponding to n=3, and the optimum recording power Pbest4 is used for the quarter round of the track, corresponding to n=4.

In this way, the optimum recording powers can be determined for each 1/n round of the track.

In FIG. 32, the method for determining n optimum recording/reproduction conditions (e.g., recording power) in correspondence with the circumferential position on the track, has been described, taking the case, where the recording power is stepwise changed from a high power to a low power for each n, as an example. This method can also be applied to the case where the recording power is stepwise changed from a low power to a high power for each n.

For determining each of the above-described n optimum recording powers, the method described with reference to FIG. 28 to FIG. 31 can be employed.

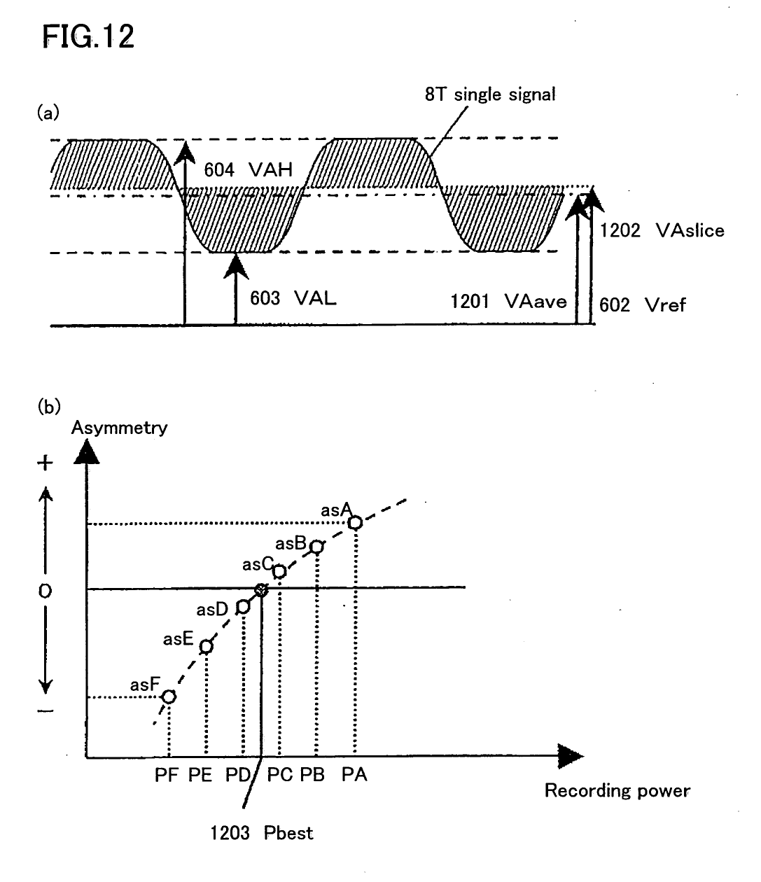

Next, with reference to FIG. 12, a method for determining the optimum recording power Pbest will be described, using the asymmetry of RF signal as an index of signal quality. Herein, on the assumption that the recording power change is identical to that in portion (b) of FIG. 6, the differences of this method from the Pbest deriving method by the modulation will be described below. Portion (a) of FIG. 12 is an enlarged view of RF signal recorded by the recording power PA, and portion (b) of FIG. 12 is a graph explaining the change in the asymmetry with respect to the recording power.

In portion (a) of FIG. 12, reference numeral 1201 denotes the average value VAave between the maximum value VAH 604 and the minimum value VAL 603 of the RF signal, and 1202 denotes a level VAslice that is obtained by slicing the RF signal waveform so that the area of each of the upper portion and the lower portion of the RF signal waveform becomes equal (see hatched portions). Thereby, in each of the four (n=4) recording areas recorded by the recording power PA, the signal levels VAH 604, VAL 603, and VAslice 1202 that have been each detected, are each averaged, and the asymmetry obtained by averaging the variations per one round of the track, is calculated by the following Expression 4.
asA=(VAslice−VAave)/(VAH−VAL) (Expression 4)
Here, VAave=(VAH+VAL)/2.

The asymmetries in the respective recording ranges recorded by the other recording powers PB, PC, PD, PE, and PF can also determined in the same way.

Portion (b) of FIG. 12 shows asymmetries asA to asF corresponding to the recording powers PA to PF, respectively. In portion (b) of FIG. 12, reference numeral 1203 denotes an optimum recording power Pbest. The method for deriving the optimum recording power by asymmetry characteristic can be implemented in the same way as in the case of the above-described modulation characteristic, except that the target value is changed from the modulation mk 701 to an asymmetry of 0 as the result of the change of the index value from the modulation to the asymmetry, and also except that the recording power at the asymmetry of 0 directly becomes the optimum power Pbest. This is because, in this embodiment, since 8T simple signal is recorded, the ideal situation is such that 8T marks and 8T spaces are alternately arranged at exactly uniform intervals, and the means for recognizing this situation from the viewpoint of signal processing is the asymmetry being 0. Therefore, the recording power at the time when the asymmetry is 0 becomes the optimum recording power Pbest.

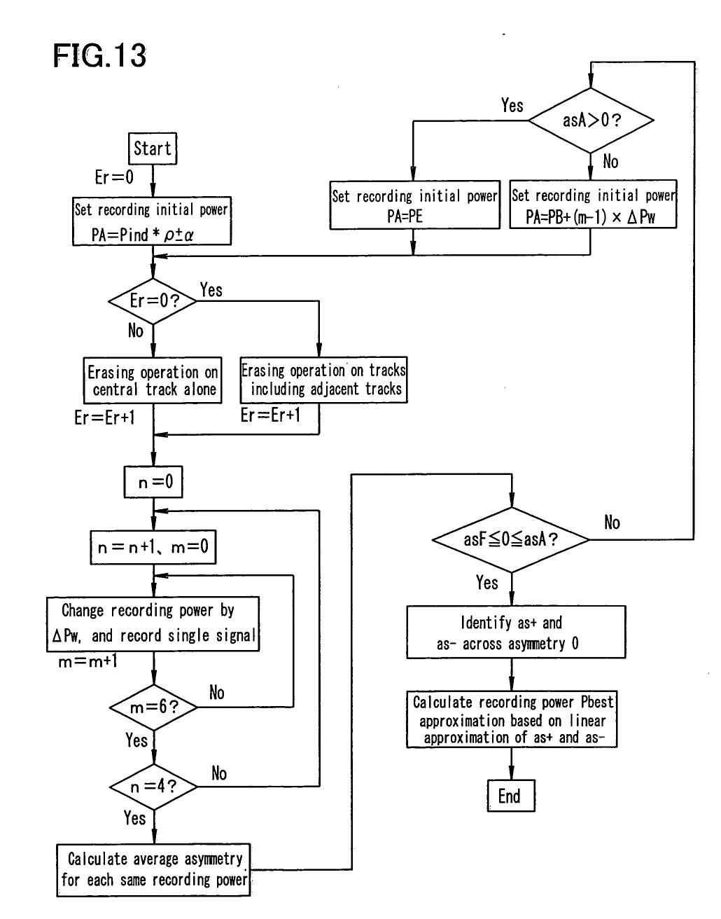

However, in order to directly determine the optimum recording power, regarding the initial condition for the recording power, it is desirable to take the recording power Pind*ρ calculated by Expression 1, or a recording power (Pind*ρ±α) in the neighborhood thereof, as an initial value. FIG. 13 collectively shows the recording power deriving processes by the asymmetry. Meanwhile, the asymmetry may also be detected after having cut DC components by AC coupling or the like.

Next, a method for determining the optimum recording power by using jitter will be described. “Jitter” refers to a difference in time between a reproduction signal and the reproduction clock Tw. As an index value indicating the signal quality, a σ/Tw (σ: standard deviation) value is used. The σ/Tw value is obtained by calculating the standard deviation a of the jitter distribution and then normalizing the calculated result using the reproduction clock Tw.

As a recording signal used herein, a single signal has been used in the method for determining the recording power by the modulation and asymmetry. However, when recording and reproduction conditions are to be determined by the use of jitter, random signals are employed. This is because, in random signals that record data signals in the used data area 102, the jitters of all recording signals are not necessarily optimum when the jitter of a single signal of other signals is improper, or under the influence of inter-code interference, even if only the jitter of single signal of interest is optimum. Therefore, when estimation is to be performed using jitter, it is desirable to perform estimation using random signals. Particularly in the case of a BD, because the conditions for recording pulses of 2T, 3T, 4T, or more are recorded in the PIC area 104, it is desirable that random signals include a 2T signal, a 3T signal, and at least one signal of 4T or more.

Regarding the recording track, when a jitter value is to be detected, it is desirable to also record on adjacent tracks. This is because,if the recording power is determined regarding one track alone, this recording power may exhibit a recording power larger than the actual optimum recording power, hence data on adjacent tracks may be undesirably overwritten when recording is continuously made on the track in the user data area 102. It is therefore desirable to also record on adjacent tracks under the same condition, bearing in mind the recording in the user data area, and to estimate the jitter value together with influences of adjacent tracks.

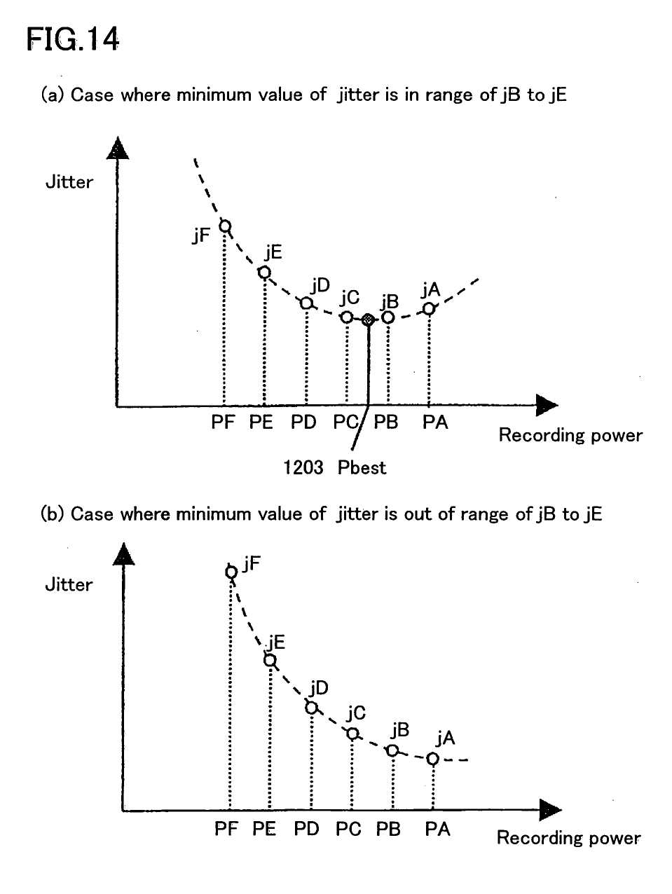

Herein, the change in recording power is the same as that in the case of portion (b) of FIG. 6. FIG. 14 shows jitters jA to jF corresponding to the recording powers PA to PF, respectively. Portion (a) of FIG. 14 shows the case where the minimum jitter value is in the range of the jitters jB to jE. In the method for deriving the optimum recording power by the jitter characteristic, there exists no target value unlike the case of the modulation and the case of the asymmetry. Instead, the recording power which provides the minimum jitter value is determined to as an optimum condition. This is because the jitter value changes depending on the reproduction condition and/or noise condition of an optical disc recording/reproduction apparatus, and because the setting of the target value becomes difficult, since the jitter values obtained are different depending on the kind of an optical disc, and in addition, no jitter value is recorded in the PIC area 104 unlike the case of the modulation. As in the case of the asymmetry, in order to directly determine the optimum recording power, regarding an initial condition for the recording power, it is desirable to take the recording power Pind*ρ calculated by Expression 1, or a recording power (Pind*ρ±α) in the neighborhood of the calculated recording power, as an initial value.

A method for detecting the minimum jitter value includes comparing a jitter value at a point before the change in recording power with a jitter value at a point after the change-in recording power and selecting the smaller of the jitter values. By repeating this operation, it is possible to search for the jitter minimum value. For example, in portion (a) of FIG. 14, the jitter value corresponding to the maximum value PA of recording power is set as a reference value. The jitter value corresponding to the adjacent recording power PB is compared with the reference value. As a result, the recording power PB is selected since the jitter value of the recording power PB is lower than the reference value. Similarly, each of the jitter values corresponding to the recording powers PC, PD, PE and PF is compared with the lower jitter value. As a result, the recording power providing the minimum jitter value, i.e., the optimum power Pbest can be selected. However, as in portion (a) of FIG. 14, when the jitter values jB and jC corresponding to the recording powers PB and PC are the same, the average value of the two recording powers is taken as an optimum power Pbest, for example.

On the other hand, as in portion (b) of FIG. 14, when the minimum jitter value has been detected at an edge of a search range of recording powers, there occurs the possibility that a recording power providing a smaller jitter value can be detected by expanding the search range of recording powers. Therefore, the minimum jitter value must be detected again by changing the research range of recording powers. Here, the track to be detected may be shifted to another track, or the same track may be reused, but in either case, the recording marks must be erased in advance as described above. The range of recording power to be executed again is determined by the recording power in which the jitter is detected to be the minimum, as a reference. In portion (b) of FIG. 14, this range corresponds to the recording power PA. Hence, if the minimum jitter value is detected in the recording power PF, the recording power PF is set to an initial value PA at a next-time change. On the other hand, if the minimum jitter value is detected in the recording power PA, a recording power (PA+(m−1)*ΔPw 601), i.e., (PA+5*ΔPw 601) is set to an initial value PA at a next-time change.

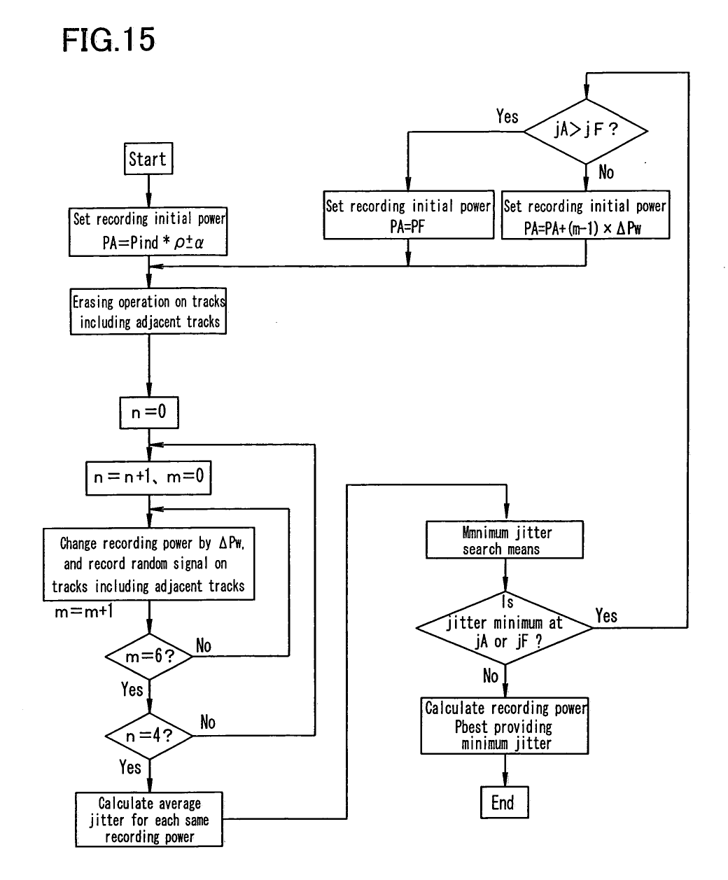

FIG. 15 collectively shows the recording power deriving processes by the jitter for n=4 and m=6. In this embodiment, it is sufficient only to obtain a recording/reproduction condition (herein, recording power) that provides the minimum jitter value. Other methods for the minimum jitter value search may also be used, such as a method for searching the minimum jitter value by a quadratic curve approximation for three points (m=3) that greatly change the recording/reproduction condition.

In this manner, the optimum recording power can be derived by repeating, n times, operations for changing the recording power m times per track.

The methods described with reference to FIG. 28 to FIG. 31 can be applied not only to the case where the optimum recording power Pbest is determined by the modulation of RF signal as an index value, but also to the case where the optimum recording power Pbest is determined by the asymmetry or jitter of RF signal, as a matter of course. This is because the methods described with reference to FIG. 28 to FIG. 31 relates to how accurately to perform recording on the optical disc while changing the recording power, and not to a step after having made such recording, e.g., a step of determining m number of averaged index values or a step of determining the optimum recording power based on the m number of averaged index values.

In the above-described embodiment, a method for determining the optimum recording power Pbest has been described. According to this method, the average value of n pieces of signal data reproduced from the area where recording has been made by the same recording power is determined, based on (m×n) pieces of signal data reproduced from the optical disc; m number of averaged index values (such as modulations, asymmetries, or the like) are determined based on the above-described average value of n pieces of signal data; and the optimum recording power Pbest is determined based on the above-described m number of averaged index values. Alternatively, however, a determining method for the optimum recording power Pbest may be used in which (m×n) number of index values (such as modulation, asymmetries, or the like) are determined based on the (m×n) pieces of signal data reproduced from the optical disc, and the average value of n number of index values corresponding to the area where recording has been made by the same recording power is determined, based on the above-described (m×n) number of index values, whereby m number of averaged index values are determined.

It should be understood that a method including the steps of determining m number of averaged index values obtained under the same recording/reproduction condition (e.g., recording power), based on (m×n) pieces of signal data reproduced from the optical disc, and determining the optimum recording/reproduction condition (e.g., recording power) based on the above-described m number of averaged index values, falls within the scope of the present invention, irrespective of how the m number of averaged index values are determined.

The recording/reproduction condition is not limited to a condition for the above-described recording power (i.e. power of the laser light). The recording/reproduction condition may be a condition for a pulse shape of the laser light described later, a condition for a tilt control of an optical head with respect to the optical disc, a condition for a tracking control of the focal position of the laser light, a condition for a focus control of the focal position of the laser light, a condition for a spherical aberration correction control, or a condition for a frequency characteristic control of a waveform equalizer. In this case, it is possible to determine an optimum recording/reproduction condition based on the m number of averaged index values, using a method similar to the method described above.

Next, a method for deriving the optimum recording pulse condition will be described. According to this method, the operation for forming recording marks by changing the recording pulse condition for the above-described multi-pulse train m times (m: an integer greater than or equal to 2), is repeated n times (n: an integer greater than or equal to 2) to derive the optimum recording pulse condition. The changing tendency of recording pulse for n=4 is the same as that in portion (a) of FIG. 5. Herein, other recording/reproduction conditions, such as the recording power and the like, are assumed to be optimum conditions. Also, the recording signals are assumed to be random signals, which are described above regarding the method for determining the recording power.

Herein, the method for deriving the recording pulse condition refers to recording compensation for detecting the edge deviation of the leading edge and trailing edge of each recording mark to optimally correct the laser output condition for the recording pulse. In this embodiment, with the edge position of a signal of 4T or more as a reference, edge deviations of 2T and 3T signals are corrected. Conversely, however, with the edge position of a 2T signal as a reference, edge deviations of signals of 3T and 4T or more may also be corrected.

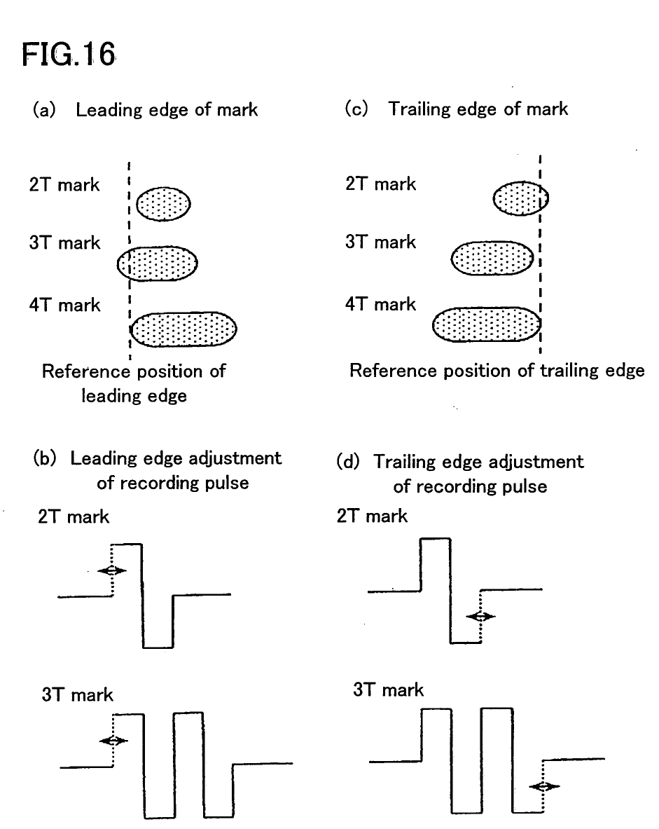

FIG. 16 explains the edge deviation of starting and trailing edges of 2T and 3T signals, and the adjustment of recording pulses. Portion (a) of FIG. 16 shows the edge deviations of 2T and 3T signals at the time when the mark leading edge of 4T signal is used as a reference. Here, the leading edge of 2T signal is recorded in a temporally delayed manner relative to the reference position, while the leading edge of 3T signal is recorded in a temporally advanced manner relative to the reference position. As shown in portion (b) of FIG. 16, the rising edge position of the top pulse in a multi-pulse train of 3T signal is fine-adjusted, thereby allowing the recordings of 2T and 3T to be started at the same position as the edge position of 4T signal. Portion (c) of FIG. 16 shows the edge deviations of 2T and 3T signals when the mark trailing edge of 4T signal is used as a reference. As in the case of the leading edge, as shown in portion (d) of FIG. 16, the last rising edge position of the top pulse in a multi-pulse train of 3T signal and 2T signal is fine-adjusted, thereby allowing the recordings of 2T and 3T to be ended at the same position as the edge position of 4T signal. Herein, for the sake of simplification, the positions where the recordings of 2T and 3T are started and ended are described as the same as the edge positions of 4T signal. To be more precise, however, when the mark leading edge of 4T signal, serving as the reference position, is represented by T4s, and the mark trailing edge of 4T signal, serving as the reference position, is represented by T4e, the position of the leading edge of each of 2T and 3T signals converges on a temporal position (T4s+ki*Tw), while the position of the trailing edge of each of 2T and 3T signals converges on a temporal position (T4e+ki*Tw), where ki is an arbitrary integer and Tw is a recording clock. Hence, if edge deviations of Δ2s and Δ2e exist at the leading edge and trailing edge of 2T, respectively, and edge deviations of Δ3s and A3e exist at the leading edge and trailing edge of 3T, respectively, then the position T2s of the leading edge of 2T signal is (T4s+ki*Tw+Δ2s); the position T3s of the leading edge of 3T signal is (T4s+ki*Tw+Δ3s); the position T2e of the trailing edge of 2T signal is (T4e+ki*Tw+Δ2e); and the position T3e of the trailing edge of 3T signal is (T4s+ki*Tw+Δ3e). Therefore, the shift amount, which is an index value indicating edge deviation, can usually been calculated as a square sum or the like of Δ2s, Δ3s, Δ2e, and Δ3e. In this embodiment, since recording operations for which the recording pulse conditions are identical to each other are performed n times, the square sum is calculated after the edge deviations Δ2s, Δ2e, Δ3s, and Δ3e each obtained by n pieces, has been averaged. The reason why the square sums that are obtained by separately calculating leading edges and trailing edges, is not used here, is that in the case where recording marks are very small as in the case of shortest marks, when the leading edges are adjusted, thermal changes at the leading edges may affect even the trailing edges which have not been adjusted such that the position of the trailing edges are changed to some extent. Hence, when the shift amount is to be used as an index value, it is desirable to collectively calculate a shift amount without separating the edge deviations of starting and trailing edges. Also, in this case, since it is prevented that the edge deviations, i.e., the shift amount, change depending on the presence or absence of recording marks on adjacent tracks, the purpose of performing an recording operation can be achieved by the central track only.

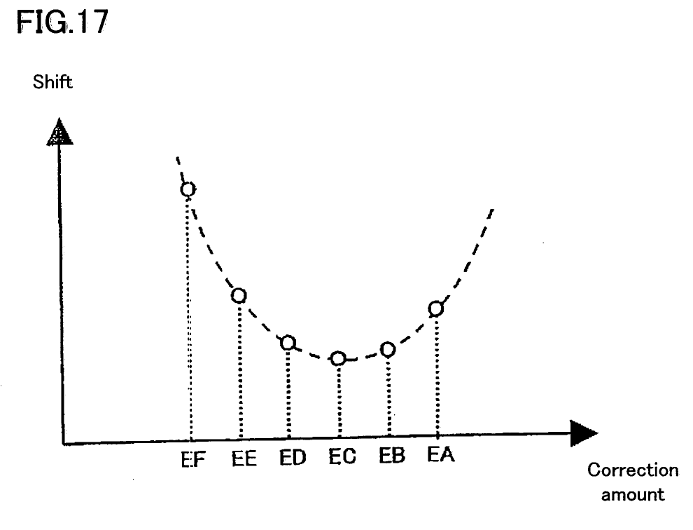

FIG. 17 shows the change in shift amount when the correction amount of recording pulse is changed into six stages (m=6) of EA to EF. Each of the shift amounts herein is averaged by n pieces of data. Here, used as an example of shift amount, is the case where the recording pulse condition recorded in the PIC area 104 is set to be an initial condition (e.g., ED in FIG. 17), and the rising edge position of the top pulse of 2T signal is changed by a fixed amount ΔTshift (e.g., Tw/32). In FIG. 17, the correction amount EC providing the minimum shift amount is selected. Here, as in the case of jitter minimum value, it is sufficient only to obtain a recording condition providing the minimum jitter, and the method for searching for the minimum shift is not particularly limited. Regarding the leading edge of 3T signal and the trailing edges of 2T and 3T, too, the correction amount for recording pulse providing the minimum shift amount is detected in a similar fashion. However, at either of the times when the track to be detected is moved to another track, and when the same track is reused, it is necessary to perform DC erasing operation. Regarding the order of making corrections, when recording is made under the initial condition of recording pulse, it is desirable to start a pulse adjustment from the edge that exhibits the maximum value in the edge deviations Δ2s, Δ2e, Δ3s, and Δ3e, that is, the edge that has caused the maximum position deviation.

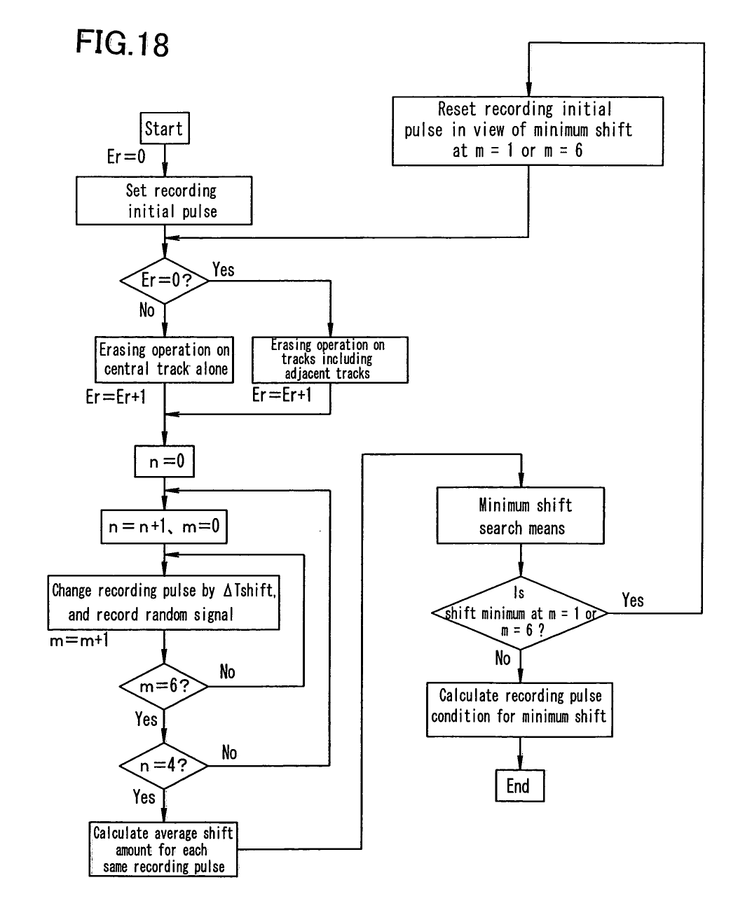

FIG. 18 collectively shows the recording pulse condition deriving process by the shift amount, for n=4 and m=6. In this manner, the operation for changing the recording pulse condition m times per track, is repeated n times to adjust the recording pulse at the starting and trailing edges of 2T and 3T signals, and thereby the optimum recording pulse condition can be derived. Here, the means for deriving the recording pulse condition is not limited to the shift amount. The recording pulse condition may also be derived from another index value such as jitter.

In comparison with the method for deriving the recording/reproduction condition from the recording power, the method for deriving it from the jitter value is different only in the recording/reproduction condition, and basically identical to the former method in the deriving process. Therefore, this deriving method by the jitter value is omitted from detailed descriptions, and only the deriving procedure in each control section will be described below.

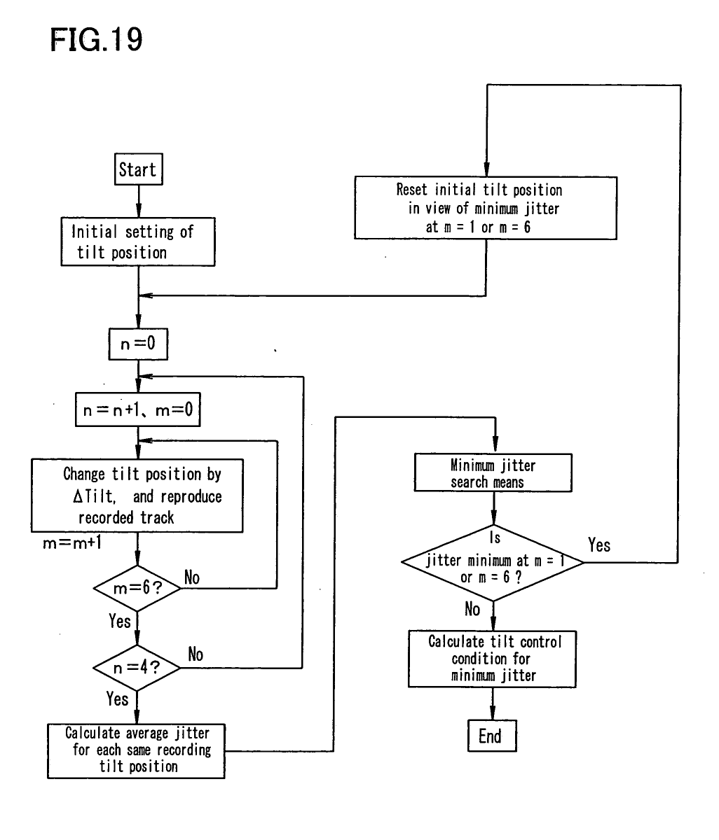

Hereinafter, descriptions will be made of a method for performing control for obtaining an optimum tilt position at the time of reproduction by repeating the reproduction operation n times (n: an integer greater than or equal to 2), while changing the tilt control for the existing recorded track m times (m: an integer greater than or equal to 2). The above-described tilt control can control the tilt of the optical head relative to the optical disc, and change the incident angle of the laser light relative to the optical disc. It is herein assumed that signals (e.g., random signals) have already been recorded under the same recording condition on a track, on which a reproduction operation is to be performed and adjacent tracks, to achieve the optimization of tilt position at the time of reproduction using jitter. Herein, the recording/reproduction conditions other than the tilt control are assumed to be optimum conditions. The changing tendency of tilt control for n=4 is the same as that in portion (a) of FIG. 5. The tilt optimizing process by the jitter for n=4 and m=6 is collectively shown in FIG. 19. Herein, there is no recording operation since an adjustment is made for the optimum tilt position to an existing recorded track. The jitter is averaged by n pieces of data. The initial setting of tilt control is set, for example, to a state where the optical head projects laser light perpendicularly to the laser disc, and the variation of the tilt position is set to a fixed amount ΔTilt (e.g., 0.1 degree).

Thereafter, the tilt position providing the minimum jitter is selected based on the litters resulting from the reproduction of the recorded track while changing the tilt position six times (i.e., m=6). However, when the minimum jitter value is detected at an edge of the tilt search range, namely, at m=1 or m=6, there is the possibility that a tilt position providing a more minimized jitter value can be detected by expanding the search range of tilt position, and therefore, it is necessary to change the search range of tilt position to again detect the minimum jitter value. The range of the tilt position search performed again may be changed toward the direction (m=1 or m=6) in which the jitter is improved.

In this manner, the control for obtaining the optimum tilt position at the time of reproduction can be performed by repeating the reproduction operation n times, while changing the tilt control m times for the existing tracks.

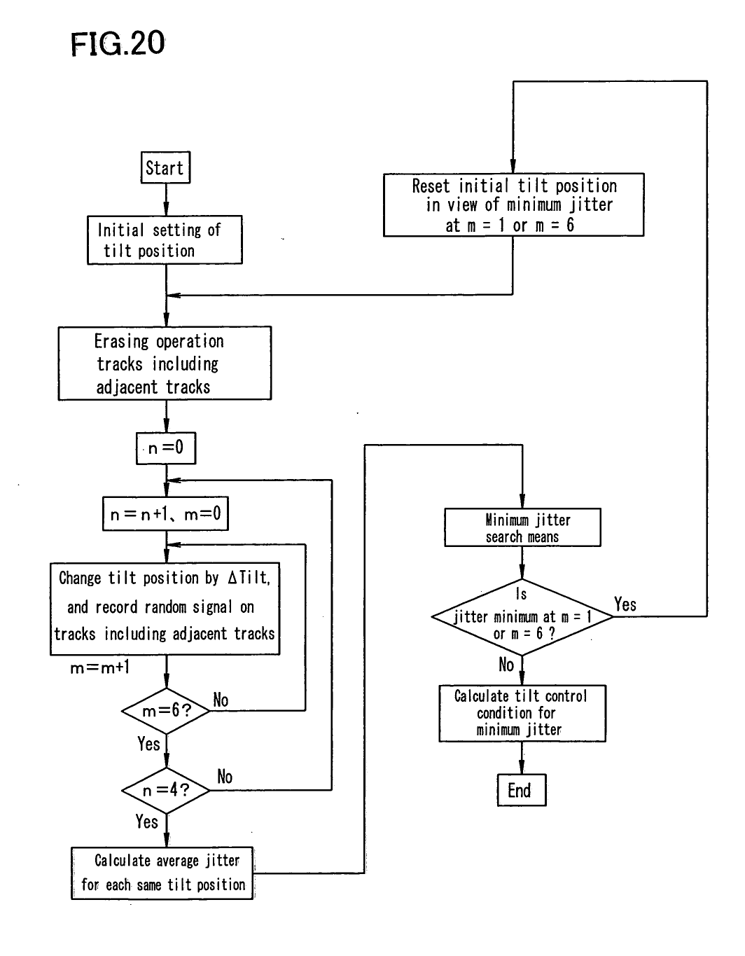

Next, references are made to a method for performing control for obtaining an optimum tilt position at the time of recording by repeating the recording operation n times (n: an integer greater than or equal to 2), while changing the tilt control m times (m: an integer greater than or equal to 2). The recording/reproduction conditions other than the tilt control are assumed to be optimum conditions to achieve the optimization of tilt position at the time of recording using jitter. The changing tendency of tilt control for n=4 is the same as that in portion (a) of FIG. 5. The tilt optimizing process by the jitter for n=4 and m=6 is collectively shown in FIG. 20.

Herein, the recording signals are assumed to be random signals, and they are also recorded on adjacent tracks. The jitter is averaged by n pieces of data. The initial setting of tilt control is set, for example, to a state where the optical head projects laser light perpendicularly to the laser disc, and the variation of the tilt position is set to a fixed amount ΔTilt (e.g., 0.1 degree).

Thereafter, the tilt position providing the minimum jitter is selected based on the jitters resulting from the reproduction of the track which has been recorded by the recording operation while changing the tilt position six times (i.e., m=6). However, when the minimum jitter value is detected at an edge of the tilt search range, namely, at m=1 or m=6, there is the possibility that a tilt position providing a more minimized jitter value can be detected by expanding the search range of tilt position, and therefore, it is necessary to change the search range of tilt position and again perform a recording operation to detect the minimum jitter value. The range of the tilt position search performed again may be changed toward the direction (m=1 or m=6) in which the jitter is improved. The track to be detected may be shifted to another track, or the same track may be used, but in either case, it is necessary to erase the recording marks in advance as described before.

In this manner, the control for obtaining the optimum tilt position at the time of recording can be performed by repeating the recording operation n times, while changing the tilt control m times.

Next, references are made to a method for performing control for obtaining an optimum focal position at the time of reproduction by repeating the reproduction operation n times (n: an integer greater than or equal to 2), while changing the tracking control m times (m: an integer greater than or equal to 2) for the existing recorded track. The above-described tracking control can control so that the focus of laser light projected from the optical head follows the optical disc, and can change the focal position of the laser light laterally relative to the tracks. It is here assumed that signals (e.g., random signals) have already been recorded under the same recording condition on a track on which a reproduction operation is to be performed and adjacent tracks, to achieve the optimization of focal position at the time of reproduction using jitter. Herein, @@the recording/reproduction conditions other than the tracking control are assumed to be optimum conditions.

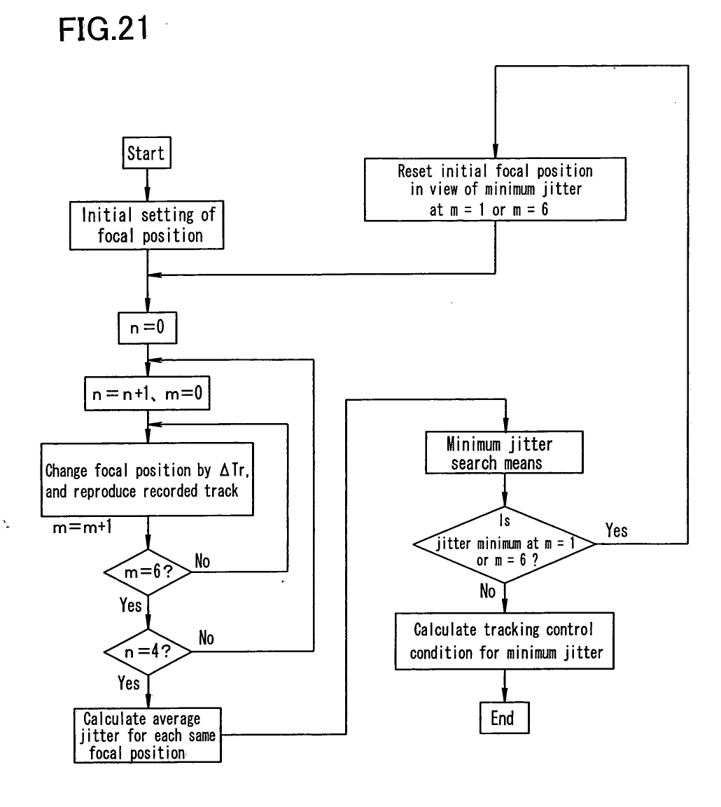

The changing tendency of tracking control for n=4 is the same as that in portion (a) of FIG. 5. The focal position optimizing process by the jitter for n=4 and m=6 is collectively shown in FIG. 21. Herein, there is no recording operation since an adjustment is made for the optimum focal position to the existing recorded track. The jitter is averaged by n pieces of data. The initial setting of tracking control is set, for example, to the central position of the track, and the variation of the focal position is set to a fixed amount ΔTr (e.g., 0.01 μm).

Thereafter, the focal position providing the minimum jitter is selected based on the jitters resulting from the reproduction of the recorded track while changing the focal position six times (i.e., m=6). However, when the minimum jitter value is detected at an edge of the search range of focal position, namely, at m=1 or m=6, there is the possibility that a focal position providing a more minimized jitter value can be detected by expanding the search range of focal position, and therefore, it is necessary to change the search range of focal position and again perform a recording operation to detect the minimum jitter value. The range of the tilt position search performed again may be changed toward the direction (m=1 or m=6) in which the jitter is improved.

In this manner, the control for obtaining the optimum focal position at the time of reproduction can be performed by repeating the reproduction operation n times, while changing the tracking control m times for the existing tracks.

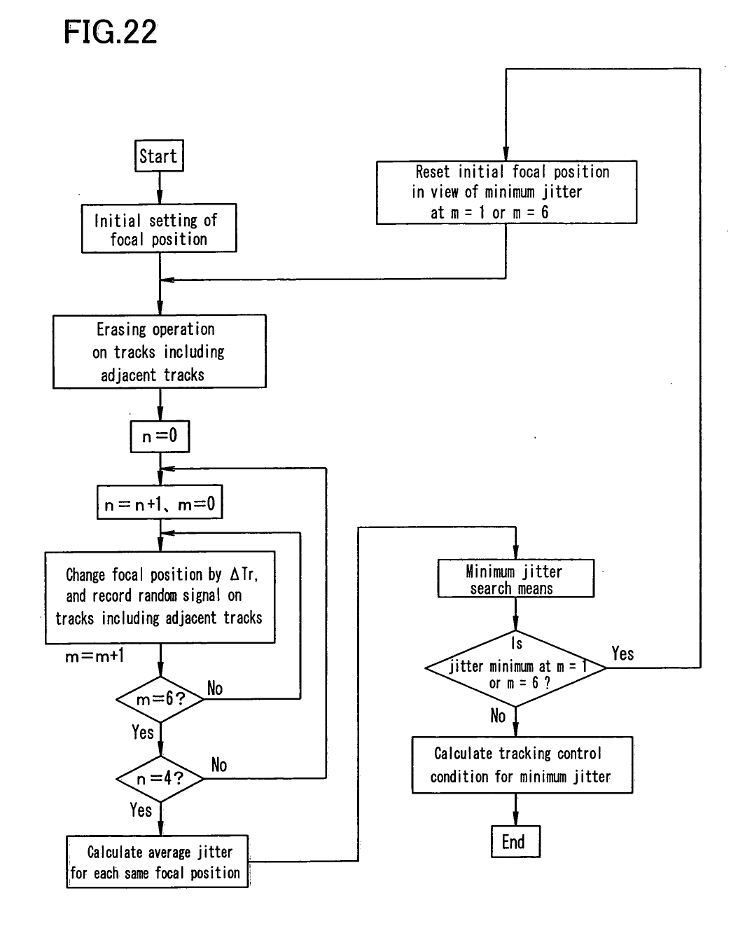

Next, descriptions are provided of a method for performing control for obtaining an optimum focal position at the time of recording by repeating the recording operation n times (n: an integer greater than or equal to 2), while changing the tracking control m times (m: an integer greater than or equal to 2). The recording/reproduction conditions other than the tracking control are assumed to be optimum conditions to achieve the optimization of focal position at the time of recording using jitter. The changing tendency of tracking control for n=4 is the same as that in portion (a) of FIG. 5. The focal position optimizing process by the jitter for n=4 and m=6is collectively shown in FIG. 22.

Herein, the recording signals are assumed to be random signals, and they are also recorded on adjacent tracks. The jitter is averaged by n pieces of data. The initial setting of tracking control is set, for example, to the central position of the track, and the variation of the focal position is set to a fixed amount ΔTr (e.g., 0.01 μm).

Thereafter, the focal position providing the minimum jitter is selected based on the jitters resulting from the reproduction of the track which has been recorded by the recording operation while changing the focal position six times (i.e., m=6). However, when the minimum jitter value is detected at an edge of the search range of focal position, namely, at m=1 or m=6, there is the; possibility that a focal position providing a more minimized jitter value can be detected by expanding the search range of focal position, and therefore, it is necessary to change the search range of focal position and again perform a recording operation 5 to detect the minimum jitter value. The range of the focal position search performed again may be changed toward the direction (m=1 or m=6) in which the jitter is improved. The track to be detected may be shifted to another track, or the same track maybe used, but in either case, it is necessary to erase the recording marks in advance as described before.

In this manner, the control for obtaining the optimum focal position at the time of recording can be performed by repeating the recording operation n times, while changing the tracking control m times.

Next, descriptions are provided of a method for performing control for obtaining an optimum focal position at the time of reproduction by repeating the reproduction operation n times (n: an integer greater than or equal to 2), while changing the focus control m times (m: an integer greater than or equal to 2) for the existing recorded track. The above-described focus control can control so that the focus of laser light projected from the optical head converges on the recording layer of the optical disc, and can change the focal position of the laser light relative to the optical axis direction. It is herein assumed that signals (e.g., random signals) have already been recorded under the same recording condition, on a track on which a reproduction operation is to be performed and adjacent tracks, to achieve the optimization of focal position at the time of reproduction using jitter. Herein, the recording/reproduction conditions other than the focus control are assumed to be optimum conditions.

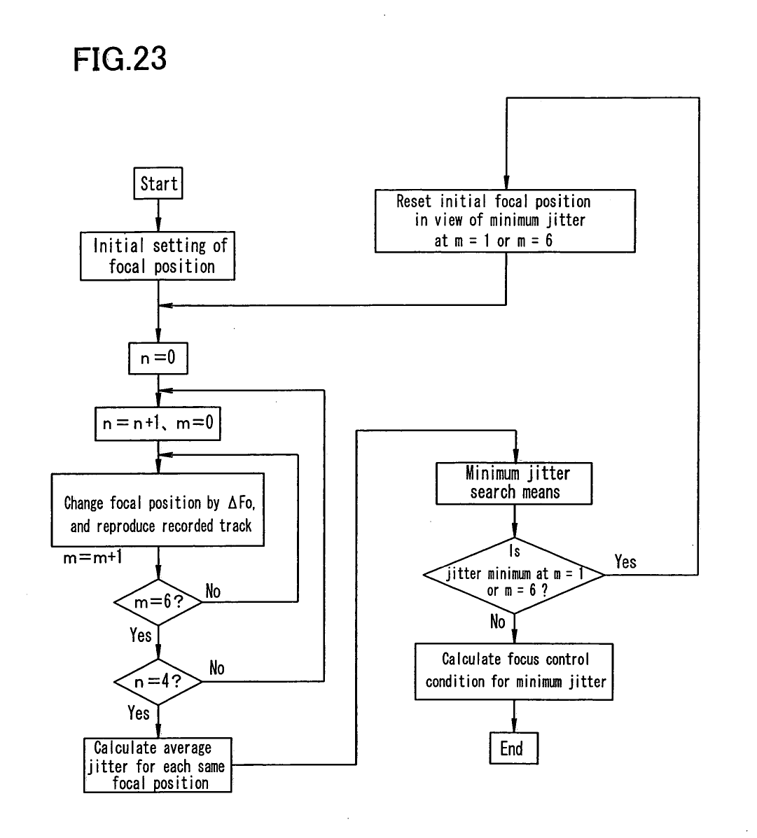

The changing tendency of focus control for n=4 is the same as that in portion (a) of FIG. 5. The focal position optimizing process by the jitter for n=4 and m=6 is collectively shown in FIG. 23. Herein, there is no recording operation since an adjustment is made for the optimum focal position to the existing recorded track. The jitter is averaged by n pieces of data. The initial setting of focus control is set, for example, to a state where the focus converges on the recording layer, and the variation of the focal position is set to a fixed amount ΔFo (e.g., 0.05 μm).

Thereafter, the focal position providing the minimum jitter is selected based on the jitters resulting from the reproduction of the recorded track while changing the focal position six times (i.e., m=6). However, when the minimum jitter value is detected at an edge of the search range of focal position, namely, at m=1 or m=6, there is the possibility that a focal position providing a more minimized jitter value can be detected by expanding the search range of focal position, and therefore, it is necessary to change the search range of focal position and again perform a recording operation to detect the minimum jitter value. The range of the focal position search performed again may be changed toward the direction (m=1 or m=6) in which the jitter is improved.

In this manner, the control for obtaining the optimum focal position at the time of reproduction can be performed by repeating the reproduction operation n times, while changing the focus control m times for the existing tracks.

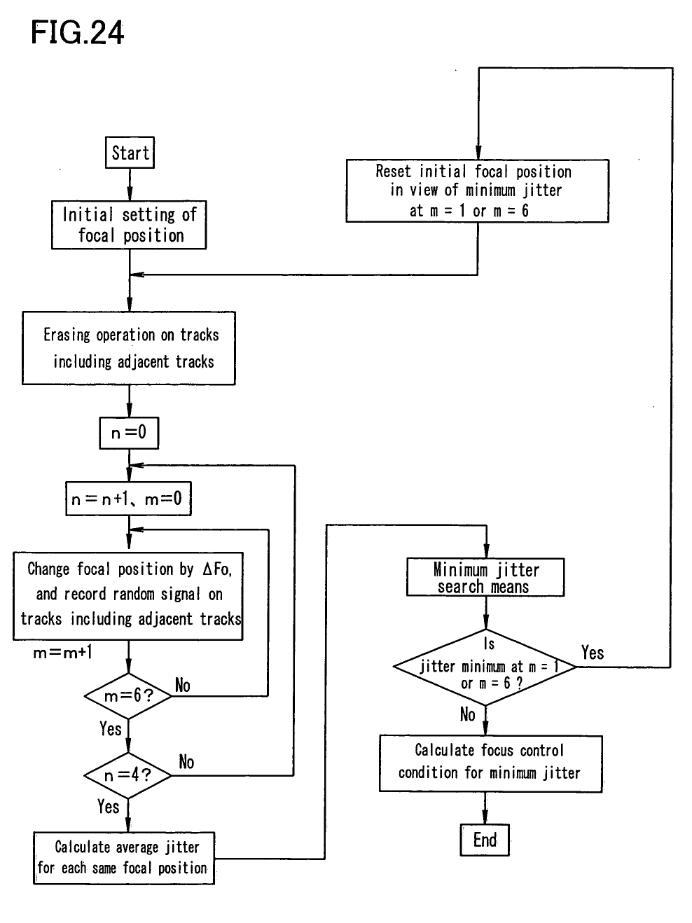

Next, descriptions are made of a method for performing control for obtaining an optimum focal position at the time of recording by repeating the recording operation n times (n: an integer greater than or equal to 2), while changing the focus control m times (m: an integer greater than or equal to 2). The recording/reproduction conditions other than the focus control are assumed to be optimum conditions to achieve the optimization of focal position at the time of recording using jitter. The changing tendency of focus control for n=4 is the same as that in portion (a) of FIG. 5. The focal position optimizing process by the jitter for n=4 and m=6 is collectively shown in FIG. 24.

Herein, the recording signals are assumed to be random signals, and they are also recorded on adjacent tracks. The jitter is averaged by n pieces of data. The initial setting of focus control is set, for example, to a state where the focal position is converged on the recording layer, and the variation of the focal position is set to a fixed amount ΔTr (e.g., 0.01 μm).

Thereafter, the focal position providing the minimum jitter is selected based on the jitters resulting from the reproduction of the track which has been recorded by the recording operation while changing the focal position six times (i.e., m=6). However, when the minimum jitter value is detected at an edge of the search range of focal position, namely, at m=1 or m=6, there is the possibility that a focal position providing a more minimized jitter value can be detected by expanding the search range of focal position, and therefore, it is necessary to change the search range of focal position and again perform a recording operation to detect the minimum jitter value. The range of the focal position search performed again may be changed toward the direction (m=1 or m=6) in which the jitter is improved. The track to be detected may be shifted to another track, or the same track may be used, but in either case, it is necessary to erase the recording marks in advance as described before.

In this manner, the control for obtaining the optimum focal position at the time of recording can be performed by repeating the recording operation n times, while changing the focus control m times.

Next, descriptions are made of a method for performing control for obtaining an optimum spherical aberration correction amount at the time of reproduction by repeating the reproduction operation n times (n: an integer greater than or equal to 2), while changing the spherical aberration correction control m times (m: an integer greater than or equal to 2) for the existing recorded track. The above-described spherical aberration correction control can control so that the spherical aberration of laser light generated on the recording layer of the optical disc becomes a minimum, and can change the spherical aberration by adjusting the spherical aberration correction amount. It is herein assumed that signals (e.g., random signals) have already been recorded under the same recording condition on a track, on which are production operation is to be performed and adjacent tracks, to achieve the optimization of spherical aberration correction amount at the time of reproduction using jitter. Herein, the recording/reproduction conditions other than the spherical aberration correction control are assumed to be optimum conditions.

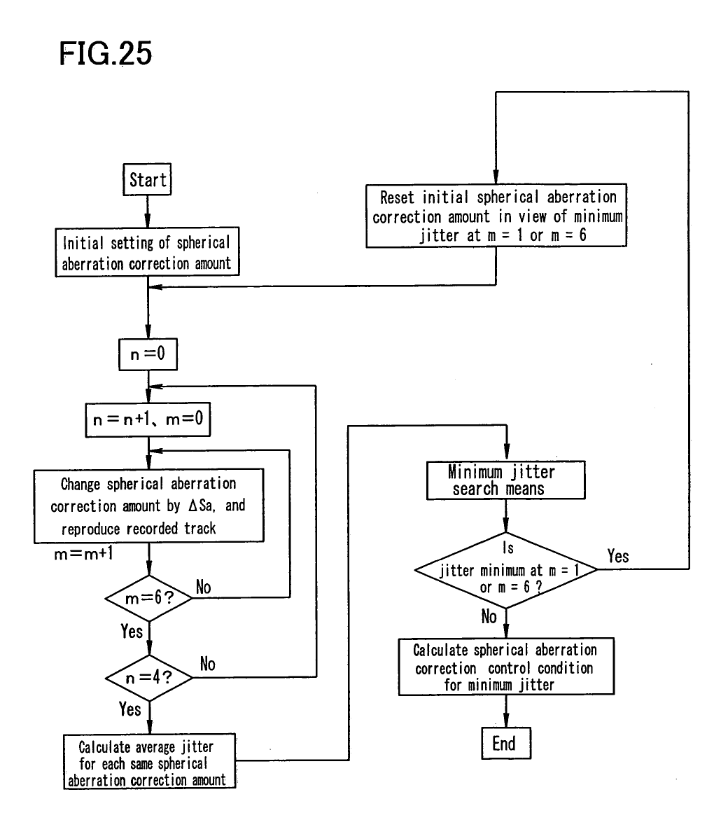

The changing tendency of spherical aberration correction control for n=4 is the same as that in portion (a) of FIG. 5. The optimizing process of spherical aberration correction amount by the jitter for n=4 and m=6 is collectively shown in FIG. 25. Herein, there is no recording operation since an adjustment is made for the optimum spherical aberration correction amount to the existing recorded track. The jitter is averaged by n pieces of data. The initial setting of spherical aberration correction control is set, for example, to a state where the spherical aberration becomes a minimum, and the variation of the spherical aberration correction amount is set to a fixed amount ΔSa (e.g., 1.0 μm).

Thereafter, the spherical aberration correction amount providing the minimum jitter is selected based on the jitters resulting from the reproduction of the recorded track while changing the spherical aberration correction amount six times (i.e., m=6). However, when the minimum jitter value is detected at an edge of the search range of spherical aberration correction amount, namely, at m=1 or m=6, there is the possibility that a spherical aberration correction amount providing a more minimized jitter value can be detected by expanding the search range of spherical aberration correction amount, and therefore, it is necessary to change the search range of spherical aberration correction amount and again perform a recording operation to detect the minimum jitter value. The range of the spherical aberration correction amount search performed again may be changed toward the direction (m=1 or m=6) in which the jitter is improved.

In this manner, the control for obtaining the optimum spherical aberration correction amount at the time of reproduction can be performed by repeating the reproduction operation n times, while changing the spherical aberration correction control m times for the existing tracks.

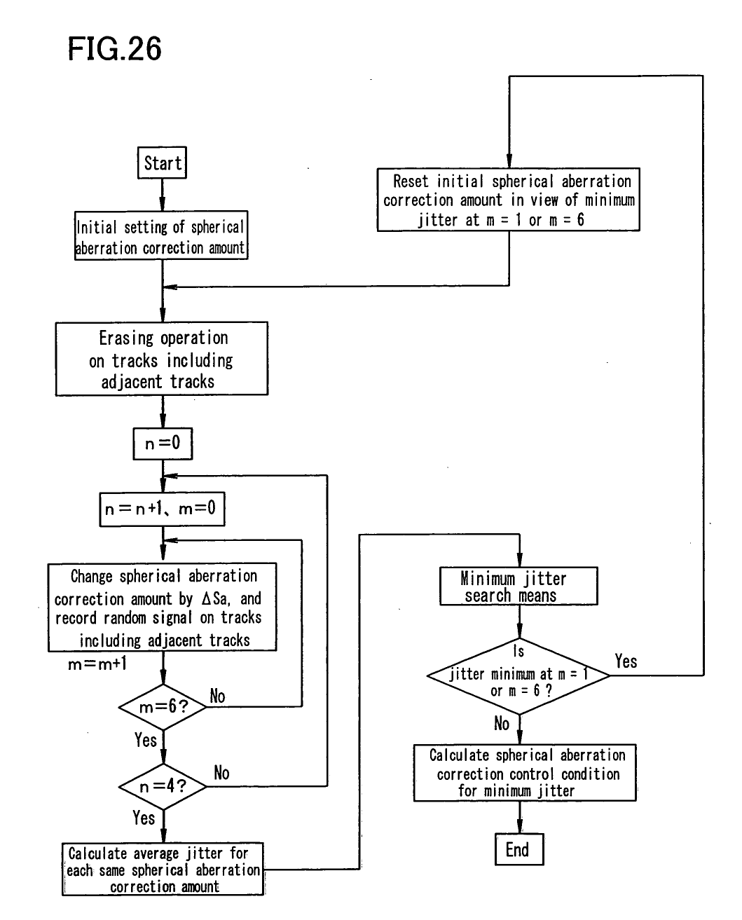

Next, descriptions are made of a method for performing control for obtaining an optimum spherical aberration correction amount at the time of recording by repeating the recording operation n times (n: an integer greater than or equal to 2), while changing the spherical aberration correction control m times (m: an integer greater than or equal to 2). The recording/reproduction conditions other than the spherical aberration correction are assumed to be optimum conditions to achieve the optimization of spherical aberration correction amount at the time of recording using jitter. The changing tendency of spherical aberration correction control for n=4 is the same as that in portion (a) of FIG. 5. The optimizing process of spherical aberration correction by the jitter for n=4 and m=6is collectively shown in FIG. 26.

Herein, the recording signals are assumed to be random signals, and they are also recorded on adjacent tracks. The jitter is averaged by n pieces of data. The initial setting of spherical aberration correction control is set, for example, to a state where the spherical aberration becomes a minimum, and the variation of the spherical aberration correction amount is set to a fixed amount ΔSa (e.g., 1.0 μm).

Thereafter, the spherical aberration correction amount providing the minimum jitter is selected based on the jitters resulting from the reproduction of the track which has been recorded by the recording operation while changing the spherical aberration correction amount six times (i.e., m=6). However, when the minimum jitter value is detected at an edge of the search range of spherical aberration correction amount, namely, at m=1 or m=6, there is the possibility that a spherical aberration correction amount providing a more minimized jitter value can be detected by expanding the search range of spherical aberration correction amount, and therefore, it is necessary to change the search range of spherical aberration correction amount and again perform a recording operation to detect the minimum jitter value. The range of the spherical aberration correction amount search performed again may be changed toward the direction (m=1 or m=6) in which the jitter is improved. The track to be detected may be shifted to another track, or the same track may be used, but in either case, it is necessary to erase the recording marks in advance as described before.

In this manner, the control for obtaining the optimum spherical aberration correction amount at the time of recording can be performed by repeating the recording operation n times, while changing the spherical aberration correction control m times.

Next, references are made to a method for performing control for obtaining an optimum frequency characteristic control at the time of reproduction by repeating the reproduction operation n times (n: an integer greater than or equal to 2), while changing the frequency characteristic control of a waveform equalizer m times (m: an integer greater than or equal to 2) for the existing recorded track. The above-described frequency characteristic control can control the frequency characteristic of the waveform equalizer to change the boost amount, boost center frequency, and the like. It is here in assumed that signals (e.g., random, signals) have already been recorded under the same recording condition on a track on which a reproduction operation is to be performed and adjacent tracks, to achieve the optimization of frequency characteristic at the time of reproduction using jitter. Herein, the recording/reproduction conditions other than the frequency characteristic control are assumed to be optimum conditions.

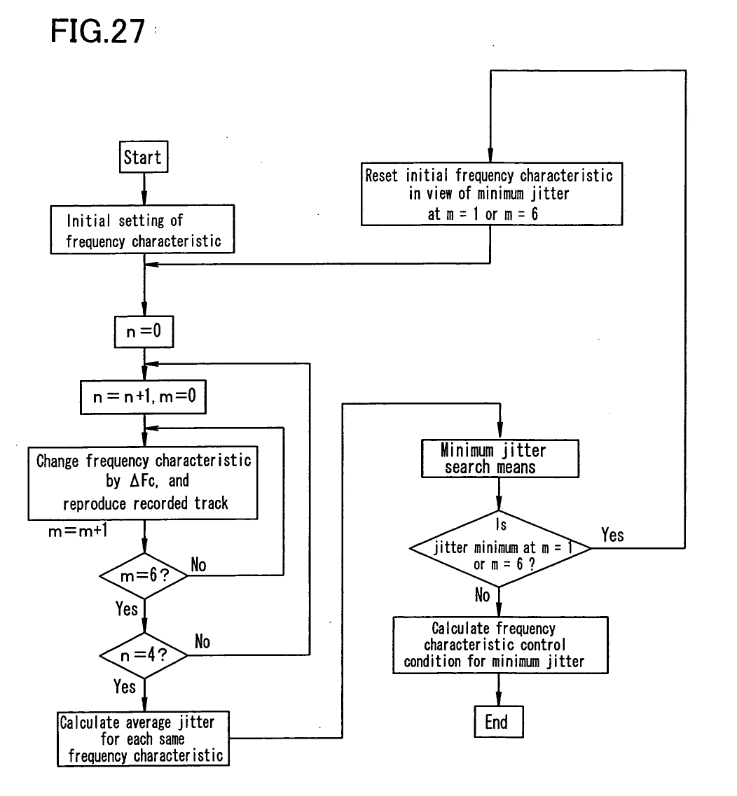

The changing tendency of frequency characteristic control for n=4 is the same as that in portion (a) of FIG. 5. The optimizing process of frequency characteristic control by the jitter for n=4 and m=6 is collectively shown in FIG. 27.

Herein, there is no recording operation since an adjustment is made for the optimum frequency characteristic to the existing recorded track. The jitter is averaged by n pieces of data. As the initial setting of frequency characteristic control, for example, the boost center frequency is set to a carrier frequency (about 16.5 MHz for a BD) having the shortest mark length, and the variation of the central frequency is set to a fixed amount ΔFc (e.g., 1.0 MHz).

Thereafter, the frequency characteristic providing the minimum jitter is selected based on the jitters resulting from the reproduction of the recorded track while changing the frequency characteristic six times (i.e.,m=6). However, when the minimum jitter value is detected at an edge of the search range of frequency characteristic, namely, at m=1 or m=6, there is the possibility that a frequency characteristic providing a more minimized jitter value can be detected by expanding the search range of frequency characteristic, and therefore, it is necessary to change the search range of frequency characteristic and again perform a recording operation to detect the minimum jitter value. The range of the frequency characteristic search performed again may be changed toward the direction (m=1 or m=6) in which the jitter is improved.

In this manner, the control for obtaining the optimum frequency characteristic at the time of reproduction can be performed by repeating the reproduction operation n times, while changing the frequency characteristic control m times for the existing tracks. Meanwhile, in this embodiment, the optimization of frequency characteristic has been sought after using jitter, but instead, the optimization of frequency characteristic of the waveform equalizer may be performed for calculating the shift amount used when performing the optimization of the above-described recording pulse condition. In this case, however, the index value is not jitter, but a shift amount. The minimum shift amount provides the optimum frequency characteristic.

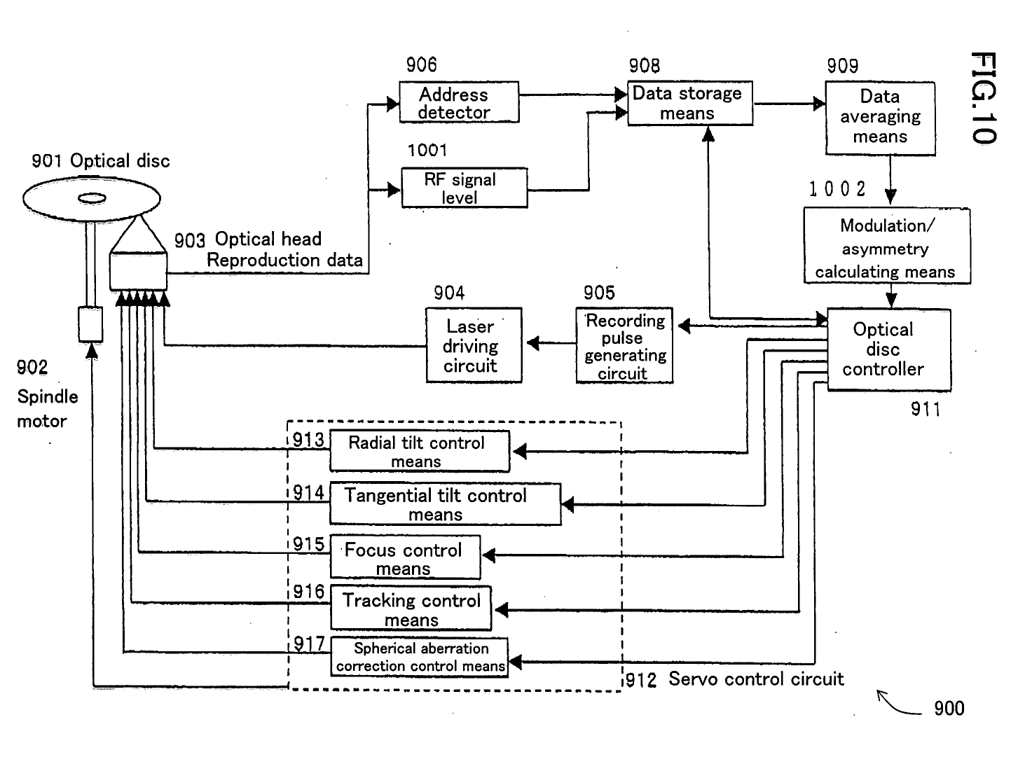

FIG. 9 shows the construction of a recording/reproduction apparatus 900 according to an embodiment of the present invention.

The recording/reproduction apparatus 900 records information on an optical disc 901, or reproduces the information recorded on the optical disc 901. The recording/reproduction apparatus 900 includes a spindle motor 902, optical head 903, laser driving circuit 904, recording pulse generating circuit 905, address detector 906, signal processing circuit 907, data storage means 908, data averaging means 909, signal processing circuit 910, optical disc controller 911, and servo control circuit 912.

The servo control circuit 912 includes a radial tilt control means 913, tangential tilt control means 914, focus control means 915, tracking control means 916, and spherical aberration correction control means 917. The servo control circuit 912 functions as an optical head control section for controlling the optical head 903.

The optical disc 901 is one described in FIG. 2. The spindle motor 902 rotates the optical disc 901. The optical head 903 irradiates the optical disc 901 with laser light. The optical head 903 also outputs a reproduction signal obtained by electrically converting reflected light from the optical disc 901.

The laser driving circuit 904 performs power control of the laser light projected from the optical head 903. The recording pulse generating circuit 905 converts modulation data into optical modulation data including a pulse train, and further fine-adjusts the pulse width, amplitude, and the like of the optical modulation data, thereby converting the data into a recording pulse signal suited for bit formation. The laser driving circuit 904 and recording pulse generating circuit 905 function as a laser light control section for controlling laser light.

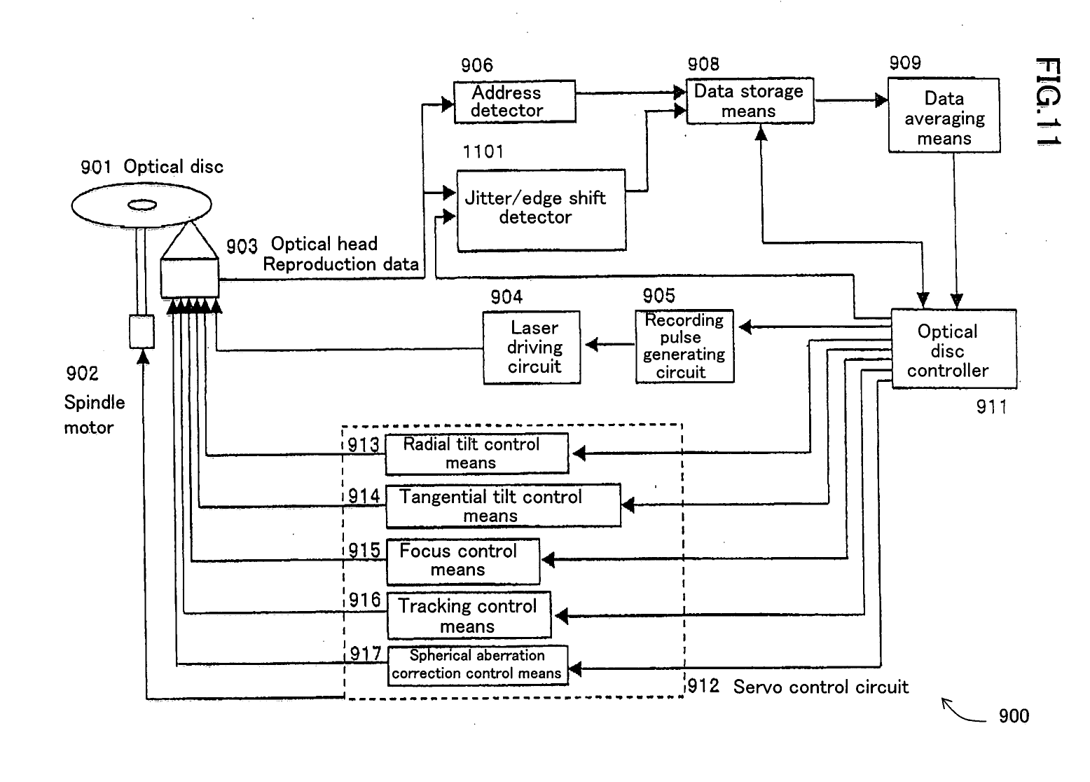

The address detector 906 detects an address signal from the reproduction signal outputted from the optical head 903. The signal processing circuit 907 processes the reproduction signal outputted from the optical head 903, and outputs an index value indicating the signal quality. This “index value indicating the signal quality” refers to the modulation or asymmetry, or the RF signal level, jitter, shift amount, or the like used when the modulation or asymmetry is calculated. The data storage means 908 stores in advance data, such as address information outputted from the address detector 906, quality index values of reproduction signals outputted from the signal processing circuit 907, recording power values corresponding to address information outputted from the optical disc controller 911. The data averaging means 909 averages data stored in the data storage means 908, the data having been detected under the same condition. The signal processing circuit 910 is used when data undergoes further processing based on the averaged data outputted from the data averaging means 909. Specifically, as shown in FIG. 10, the signal processing circuit 910 is used when the RF signal-level is detected by an RF signal level detector 1001 (corresponding to the signal processing circuit 907) and after the RF signal levels have been averaged, the modulation, asymmetry, or the like is calculated by a modulation/asymmetry calculating means 1002 (corresponding to the signal processing circuit 910). On the other hand, no signal processing circuit 910 is needed when, as shown in FIG. 11, the jitter or shift amount is calculated by a jitter/edge shift detector 1101 (corresponding to the signal processing circuit 907), and the average jitter and shift amount can be obtained by data averaging means 909 alone. Hence, the signal processing circuit 907 and signal processing circuit 910 have the same the role of calculating the index value of signal quality.

Herein, at least one of the signal processing circuit 907 and signal processing circuit 910 is configured not to process a reproduction signal obtained from the recording range of symbol T shown in portion (a) of FIG. 28 and portion (a) of FIG. 29. Such processing can be easily achieved, for example, by distinguishing the recording range of symbol T from the other recording ranges (recording ranges of symbols A to E). Also, at least one of the signal processing circuit 907 and signal processing circuit 910 is configured not to process a reproduction signal obtained from the measurement range other than that shown in portion (c) of FIG. 30. Such processing can be easily achieved, for example, by distinguishing a portion of the range within the recording range (i.e., the leading portion of the recording range) from the other range (i.e., a portion other than the leading portion of the recording range).

The optical disc controller 911 controls all kinds of control sections based on obtained index values of signal quality. Herein, “all kinds of control sections” include a servo control circuit 912 including tilt control means (radial tilt control means 913 and tangential tilt control means 914), focus control means 915, tracking control means 916, and spherical aberration correction control means 917; a laser driving circuit 904; and a recording pulse generating circuit 905. When the jitter or shift amount is detected as shown in FIG. 11, all kinds of control sections further includes frequency characteristic control means for controlling frequency characteristics (such as the boost amount and boost center frequency) of the waveform equalizer (not shown) existing in the jitter/edge shift detector 1101 and performing wave shaping. Herein, the optical disc controller 911 adjusts the recording power, servo state, and the like in response to results outputted from the signal processing circuit 910.

The servo control circuit 912 includes the tilt control means and the focus control means, and performs a rotational control of the spindle motor 902, a positional control of the optical head 903, and focus and tracking control.

The tilt control means controls the tilt of the optical head 903 relative to the optical disc. Specifically, the radial tilt control means 913 tilts the optical head in the radial direction, while the tangential tilt control means 914 tilts the optical head in the tangential direction.

The focus control means 915 performs control such that the focus of laser light projected from the optical head 903 converges on the recording layer of the optical disc.

The tracking control means 916 performs control such that the focus of laser light projected from the optical head 903 follows the track of the optical disc.

The spherical aberration correction control means 917 control the spherical aberration of laser light, the spherical aberration occurring on the recording layer of the optical disc 901.

Herein, in order to clarify that the optical disc controller 911 controls each of the control sections for recording/reproduction to be in the optimum conditions, a method for controlling the laser driving circuit 904 in the circumference of track is discussed below. Descriptions are made with reference to FIG. 10, taking the case where the recording power with respect to the optical disc is determined by the modulation, as an example.

First, the optical disc controller 911 determines an erasing power by information recorded on the optical disc 901, and instructs three tracks around a track on which recording is to be made, to perform erasing operation.

Next, the optical disc controller 911 determines the initial power value of a recording power by information recorded on the optical disc 901. Then, the optical disc controller 911 instructs the recording pulse generating circuit 905 to generate a pulse waveform of a single signal (e.g., a 8T single signal serving as a (1, 7) modulation code) of the longest mark of modulation. In addition, the optical disc controller 911 instructs the laser driving circuit 904 to perform, n times, the operation for changing, from the initial power value, the recording power per unit address on the track by a fixed amount (e.g., 5% of the initial power) by m times, and also instructs the laser driving circuit 904 to record the 8T single signal data by a recording power corresponding to each address section.

Next, the recorded signal data is reproduced, and an RF signal level for each address is detected by the RF signal level detector 1001. The information such as the recorded addresses and set powers, and detected RF signal levels are stored in the data storage means 908. The RF signal levels recorded under the same recording power condition are data-averaged, and an average modulation is calculated by the modulation/asymmetry calculating means 1002.

Furthermore, the optical disc controller 911 selects two modulation nearest to modulation information mk recorded on the optical disc 901, out of m modulations averagely calculated, and a power by which the mk is presumed to be detected by the linear approximation of the two modulations is estimated. By multiplying the estimated power by a constant ρ recorded on the optical disc 901, the optical disc controller 911 determines the optimum recording power to be recorded in the user data area 102, and instructs the laser driving circuit 904 to output the above-described optimum recording power. On the other hand, if the mk is not within the range of m modulations, the optical disc controller 911 changes the initial power value, and again performs erasing operation and recording operation. These operations are repetitively executed until the mk enters the range of the m modulations.

In this embodiment, an example of an output control method for the recording power of the laser driving circuit 904 has been explained, but naturally, the present invention can be applied to other control sections than the laser driving circuit 904. Herein, the other control sections include, for example, the radial tilt control means 913, tangential tilt control means 914, focus control means 915, tracking control means 916, and spherical aberration correction control means 917; and the frequency characteristic control means provided in the recording pulse generating circuit 905 and jitter/edge shift detector 1101.

With the above-described features, by changing the recording/reproduction condition along one round of track in the optical disc where there exist variations in track width, reflectance, or the like along the circumference of the track, it is possible to determine an average recording/reproduction condition along the circumference of the track. It is also possible to perform more effective recording/reproduction since unnecessary tracks are not used.

In the above-described embodiment, descriptions have been made regarding a one-layered recording layer, i.e., a single-layer disc. However, the present invention can also be implemented with respect to optical discs having a multilayer structure of two or more layers, by using recording information recorded on each layer in the optical disc. Also, in this embodiment, the recording layer has been described as having a spiral track configuration, but the present invention can also be implemented with respect to optical discs having a concentric track configuration. Moreover, the present invention can be implemented not only with respect to groove sections but also with respect to the land-groove recording system, which is used for DVD-RAM and the like, and in which recording is made on the land portion thereof.

The recording code used when the recording power is determined by the modulation characteristic in the above-described embodiment, can be applied to the case of the (1, 7) modulation code, of which the longest mark is 8T. The present invention can also be implemented with respect to a recording code such as an 8-16 modulation code used for DVD, by changing the longest mark into 11T. The present invention can be applied to other recording codes if the longest mark is set. Provided that the same mark width as the longest mark, other mark lengths (e.g., 7T) may also be used.

The signal waveform for deriving a modulation is not limited to a single signal. The modulation may also be derived by using the maximum value and the minimum value of a reproduction signal after having recorded random signals including the longest mark.

In the above-described embodiment, for calculating the recording power Pk, a linear approximation has been used, but other approximation curves such as a quadratic curve approximation may instead be employed. Furthermore, other deriving methods, such as a method for calculating the recording power Pbest by the tilt change of the tangent in the modulation characteristic may also be used.

Also, in the above-described embodiment, although descriptions have been provided regarding the case where the recording pulse waveform constitutes a multi-pulse train, the present invention can also be applied to the case of mono-pulse.

The index value indicating the signal quality used for the optimization of recording/reproduction condition in this embodiment may be another index value such as the error rate, or the reliability index value of the decoded result in the maximum likelihood decoding system.

The m-times changing tendency of the recording/reproduction condition in this embodiment is such that the changes are made by a fixed value so that the control means can easily execute changes, but the changes may instead be made by using non-fixed values.

From the viewpoint of the performance of optical disc recording/reproduction apparatus, the changing of the recording/reproduction condition may require a significant time. Therefore, the present invention does not necessarily need to repeat, n times, the recording/reproduction condition that is implemented m times during the time period when the optical disc rotate once. It is sufficient that, for example, the result obtained by recording during a first rotation at n places under one condition, and recording during a second rotation at n places under a next condition, eventually becomes equal to the result obtained by repeating, n times, the operation for changing recording/reproduction condition m times per round of the track.

### INDUSTRIAL APPLICABILITY

In various recording/reproduction apparatuses that utilize recording or reproducing of data signals for an optical disc or other medium by laser light of an electromagnetic force, such as a DVD drive used for data storage in a personal computer, a DVD recorder and a BD recorder for image recording, and other equipment, the present invention can be used in the adjustment stage of recording/reproduction conditions in the data area, and can be applied to other uses, such as the selection of location where the adjustment of recording/reproduction condition is made.

Since the recording/reproduction conditions including variations in the track width, reflectance, and the like along the circumference of the track are determined, an average recording/reproduction condition can be determined with respect to the circumference of the track. Furthermore, since the optimum condition is detected by changing the recording/reproduction condition on one track, unnecessary tracks are not used, and further the processing time can be reduced, as compared with the method for detecting. the optimum condition by performing recording/reproduction operation under one condition per track in order to detect variations in the circumference of the track.

1. A recording/reproduction method for recording information onto an optical disc or reproducing the information recorded on the optical disc, the recording/reproduction method comprising the steps of:
repeating one of a recording operation and a reproduction operation for the optical disc n times (n: an integer greater than or equal to 2) while changing a recording condition or a reproduction condition in a stepwise and monotonous manner m times (m: an integer greater than or equal to 2);
determining m number of averaged index values obtained under the same recording condition or the same reproduction condition, based on the (m×n) pieces of signal data reproduced from the optical disc;
determining an optimum recording condition or an optimum reproduction condition based on the m number of averaged index values; and
performing at least one of the recording operation and the reproduction operation for the optical disc in accordance with the optimum recording condition or the optimum reproduction condition.

2. A recording/reproduction method according to claim 1, wherein m number of recording/reproduction ranges to be recorded using m number of recording conditions or to be reproduced using m number of reproduction conditions are provided for each of n number of the repeated operations, the recording condition or the reproduction condition corresponding to a leading recording/reproduction range of the m number of recording/reproduction ranges and the recording condition or the reproduction condition corresponding to a recording/reproduction range following the leading recording/reproduction range are set to be the same, and a reproduction signal obtained from the leading recording/reproduction range is not used to determine the index value.

3. A recording/reproduction method according to claim 2, wherein the length of the leading recording/reproduction range is twice the length of the recording/reproduction range following the leading recording/reproduction range.

4. A recording/reproduction method according to claim 1, wherein the step of determining m number of averaged index values includes the steps of:
determining an average value of n pieces of signal data obtained under the same recording condition or the same reproduction condition, based on the (m×n) pieces of signal data; and
determining the m number of averaged index values based on the average value of the n pieces of signal data.

5. A recording/reproduction method according to claim 1, wherein the step of determining m number of averaged index values includes the steps of:
determining (m×n) number of index values based on the (m×n) pieces of signal data; and
determining the m number of averaged index values by determining an average value of n pieces of index values obtained under the same recording condition or the same reproduction condition based on the (m×n) number of index values.

6. A recording/reproduction method according to claim 1, wherein the recording condition or the reproduction condition includes at least one of:
a condition for a power of laser light applied to the optical disc;
a condition for a pulse shape of the laser light;
a condition for a tilt control of an optical head with respect to the optical disc;
a condition for a tracking control of a focal position of the laser light;
a condition for a focus control of a focal position of the laser light;
a condition for a spherical aberration correction control of the laser light; and
a condition for a frequency characteristic control of a waveform equalizer.

7. A recording/reproduction method according to claim 1, wherein the index value indicates any one of modulation, asymmetry, jitter and a shift amount of a recording mark, the shift amount representing a deviation of a leading edge or a trailing edge of the recording mark from a reference position.

8. A recording/reproduction method according to claim 1, wherein the m number of index values are determined based on an average value of RF signal levels obtained by reproducing a single signal recorded on the optical disc using laser light having the same power.

9. A recording/reproduction method according to claim 8, wherein a longest mark of a modulation code is used as the single signal.

10. A recording/reproduction method according to claim 1, further comprising the step of:
performing an erasing operation on a track and an adjacent track which is adjacent to the track of the optical disc, before recording information on the track.

11. A recording/reproduction method according to claim 1, wherein, in each of the n number of repeated operations, the recording condition or the reproduction condition increases by a fixed value in a stepwise and monotonous manner, or decreases by a fixed value in a stepwise and monotonous manner.

12. A recording/reproduction method according to claim 1, wherein laser light for forming a recording mark on the optical disc is a multi-pulse train.

13. A recording/reproduction apparatus for recording information onto an optical disc, or reproducing the information recorded on the optical disc, the recording/reproduction apparatus comprising:
an optical head for irradiating the optical disc with laser light;
a laser light control section for controlling the laser light;
an optical head control section for controlling the optical head;
an optical disc controller for controlling the laser light control section and the optical head control section to repeat one of a recording operation and a reproduction operation for the optical disc n times (n: an integer greater than or equal to 2) while changing a recording condition or a reproduction condition in a stepwise and monotonous manner m times (m: an integer greater than or equal to 2); and
a signal processing section for determining m number of averaged index values obtained under the same recording condition or the same reproduction condition, based on the (m×n) pieces of signal data reproduced from the optical disc, wherein the optical disc controller determines an optimum recording condition or an optimum reproduction condition based on the m number of averaged index values, and controls the laser light control section and the optical head control section to perform at least one of the recording operation and the reproduction operation for the optical disc in accordance with the optimum recording condition or the optimum reproduction condition.

14. A recording/reproduction apparatus according to claim 13, wherein m number of recording/reproduction ranges to be recorded using m number of recording conditions or to be reproduced using m number of reproduction conditions are provided for each of n number of the repeated operations, the recording condition or the reproduction condition corresponding to a leading recording/reproduction range of the m number of recording/reproduction ranges and the recording condition or the reproduction condition corresponding to a recording/reproduction range following the leading recording/reproduction range are set to be the same, and a reproduction signal obtained from the leading recording/reproduction range is not used to determine the index value.

15. A recording/reproduction apparatus according to claim 14, wherein the length of the leading recording/reproduction range is twice the length of the recording/reproduction range following the leading recording/reproduction range.

16. A recording/reproduction apparatus according to claim 13, wherein the signal processing section determines an average value of n pieces of signal data obtained under the same recording condition or the same reproduction condition, based on the (m×n) pieces of signal data, and determines the m number of averaged index values based on the average value of the n pieces of signal data.

17. A recording/reproduction apparatus according to claim 13, wherein the signal processing section determines (m×n) number of index values based on the (m×n) pieces of signal data, and determines the m number of averaged index values by determining an average value of n pieces of index values obtained under the same recording condition or the same reproduction condition based on the (m×n) number of index values.

18. A recording/reproduction apparatus according to claim 13, wherein the recording condition or the reproduction condition includes at least one of:
a condition for a power of laser light applied to the optical disc;
a condition for a pulse shape of the laser light;
a condition for a tilt control of an optical head with respect to the optical disc;
a condition for a tracking control of a focal position of the laser light;
a condition for a focus control of a focal position of the laser light;
a condition for a spherical aberration correction control of the laser light; and
a condition for a frequency characteristic control of a waveform equalizer.

19. A recording/reproduction apparatus according to claim 13, wherein the index value indicates any one of modulation, asymmetry, jitter and a shift amount of a recording mark, the shift amount representing a deviation of a leading edge or a trailing edge of the recording mark from a reference position.

20. A recording/reproduction apparatus according to claim 13, wherein the m number of index values are determined based on an average value of RF signal levels obtained by reproducing a single signal recorded on the optical disc using laser light having the same power.

21. A recording/reproduction apparatus according to claim 20, wherein a longest mark of a modulation code is used as the single signal.

22. A recording/reproduction apparatus according to claim 13, further comprising a section for performing an erasing operation on a track and an adjacent track which is adjacent to the track of the optical disc, before recording information on the track.

23. A recording/reproduction apparatus according to claim 13, wherein, in each of the n number of repeated operations, the recording condition or the reproduction condition increases by a fixed value in a stepwise and monotonous manner, or decreases by a fixed value in a stepwise and monotonous manner.

24. A recording/reproduction apparatus according to claim 13, wherein laser light for forming a recording mark on the optical disc is a multi-pulse train.
